(19) United States
(12) Patent Application Publication
(10) Pub. No.: US 2013/0218608 A1
(43) Pub. Date: Aug. 22, 2013

(54) Pre-Fixe.com™- A World Wide Web Industry-Specific Gateway and Venue to Sell Merchant Products and Services Online

(71) Applicant: Ana Huson, Kentfield, CA (US)

(72) Inventor: Ana Huson, Kentfield, CA (US)

(21) Appl. No.: 13/309,405

(22) Filed: Dec. 1, 2011

(51) Int. Cl. G06Q 30/06; G06Q 50/12

(52) U.S. Cl. CPC G06Q 30/0603; G06Q 50/12
USPC 705/5; 705/15; 705/14.27

(57) ABSTRACT

This environmentally friendly System Method and software package powered by Pre-Fixe.com is specifically designed to offer an ongoing solution that enables Merchants within specific industries, (starting with the restaurant industry) to sell their goods and services online from a single portal. Through this invention, multiple Merchants are invited to create their own automated Microsites and shopping carts to sell a uniquely designed Suite of E-Products comprised of: E-Gift Certificates, Customized Event and Group Dining Software, Ongoing Pre-Fixe™ Menus and Pre-Fixe™ it Menus, Special Offers, a proprietary All-Inclusive Dining Calculator Software and custom industry search filters. The System Method includes a backend management area called “My Account” for Merchants, Consumers and Pre-Fixe Administration to view and manage historical purchases deduct and issue credits, re-gift and reward loyalty. Printing to redeem credits is not necessary.

### 1. FIELD OF THE INVENTION

The invention relates to: a) bringing together individual merchants within specific industries currently not taking full advantage of e-commerce, into a single internet portal to activate the sale of their goods and services online starting with the restaurant industry; b) proprietary industry software programmed to customize the sale of their goods and services through a Suite of E-Products comprised of E-Gift Certificates, Customized Event and Group Dining Software, Ongoing Pre-Fixe™ Menus, Special Offers, a proprietary All-Inclusive Dining Calculator and industry-related custom search filters; and c) a customized back end management software that allows consumers, restaurants and Pre-Fixe.com to manage sales, credits, events, re-gifting, loyalty and payment gateway.

### 2. BACKGROUND OF THE INVENTION

Service-oriented businesses such as restaurants have limited hours of operation when they perform their sales. During these limited hours, they are fully staffed in the back and front of the house to attend to their customers on a one-to-one basis. During non-service hours, limited personnel work on kitchen prep work, hygiene and accounting, purchasing and cost control.

To sell a gift card, an employee needs to answer a phone, receive a fax or an email with the credit card information. After the credit card is run through their bank terminal, the employee must activate the card manually through a magnetic card reader and physically mail it or have it picked up by the consumer. Although there are some single multi-unit restaurant chains beginning to offer online sales of E-Gift Certificates as isolated cases, there is no single portal where the industry comes together to sell E-Gift Certificates as well as other goods and services online.

Currently hosting large parties and events at restaurants is a cumbersome process. Restaurants must physically hand out, fax or email their printed group menus, which are not typically posted on their websites. Restaurants also spend a substantial amount of time and money employing and training event personnel who meet with customers to make their menu selections. This can be a very involved process that takes numerous phone calls, meetings and emails to arrive at their customized menu and finalize their event plans. Event planners spend valuable time researching for a venue that meets their criteria. Most of this information is not readily found online and certainly not at one source. This information includes, but is not limited to, features as varied as room capacity, full bar, ambiance and other qualities ranging from valet parking to gluten free menu availability.

Restaurants today are embracing price fixed menus as part of their promotional and sometimes daily offerings because it saves them time and money while maximizing their profits. Consumers perceive these price fixed menus as special seasonal tastings that allow them to save money. Restaurants do not currently have a way to sell these price fixed menus online except through an occasional promotional opportunity that may include a deal of the day offer. These promotions have proven to increase traffic at restaurants for limited periods of time only. Currently, there is no ongoing e-commerce solution that enables restaurants to pre-sell price fixed menus to fill tables during off-peak hours and increase sales.

In trying to promote business, some restaurants and other similar industries have engaged in deals of the day offers, which bring consumers to establishments mostly during the limited duration of the promotion. These special offers do not tend to develop loyal customers nor are they profitable for participating merchants. In fact many merchants find that participation in these types of promotions will result in a net loss due to the price reduction and the consolidator commission. Restaurants currently do not have access to software that gives them full control over posting their own special offers any time on their own terms to develop customer loyalty.

More and more consumers have become accustomed to making online purchases for their travel needs, and planning and paying for these services online. There is no single portal that allows consumers to budget, plan ahead and pre-pay for their dining preferences.

Our research and experience indicates that the restaurant industry needs to increase their online presence and find more ways to sell online. Our invention attempts to fulfill this void and empower industries not currently taking advantage of e-commerce to sell from a single Internet portal. The Pre-Fixe.com invention is a customized solution to help restaurants save time and money while increasing cash flow and profits.

Selling E-Gift Certificates online reduces employee costs while offering a green, environmentally friendly solution which allows consumers to send electronic gift certificates to others.

Our ingenious Event & Group Dining Software enables consumers to plan a group event, customize menus and automatically the system sends the restaurant a completed, custom menu ready to print. An event organizer has the option of pre-paying the full amount or issuing separate checks through our payment gateway allowing guests to individually pre-pay for their portion of the meal.

An added-feature to our invention is the All-Inclusive Dining Calculator that helps consumers more accurately estimate the cost of dining at a particular restaurant which includes information about the average cost for beverage, wine, corkage, gratuity and even sales tax.

A unique feature of the invention enables the restaurant to upload an ongoing price fixed menu or create a custom one to pre-sell them online at Pre-Fixe.com. This helps the restaurant fill empty tables during off peak hours and increase their profitability.

The Pre-Fixe.com software provides a profitable solution that allows merchants to sell Special Offers for a limited time or on an ongoing basis, which brings in new customers and rewards loyalty.

Pre-Fixe.com allows merchants to issue promotional credits to reward customer loyalty and allows consumers to consolidate unused credit balances for their own use or to re-gift to others.

### 3. SUMMARY OF THE INVENTION

The invention is comprised of multiple objectives, including but not limited to the following:

Providing an industry portal that invites selected restaurants to create a custom mini-website, which we herein after refer to as a Microsite, where they can upload the following information: Pricing, group menus, price fixed menus, special offers and an editorial page where they can post pictures of their establishment and details of their services. The system also allows them to post images of their key personnel, links to their social media pages, menus on their website, reservation systems and more to allow them to sell their goods and services 24 hours per day, 7 days per week;

Reducing the overall cost of services by lowering personnel and office overhead; Allowing consumers to plan, budget and pre-pay for their dining experiences; Sending E-Gift Certificates instantly from a computer or a mobile device;

Increasing merchant cash flow by receiving payments prior to providing consumers with goods and services;

Increasing merchant profitability through the pre-sale of price fixed menus to fill empty tables during off peak hours;

Offering consumers an array of search filters that are custom industry icons to find details that meet their criteria. This information includes, but is not limited to, features as varied as room capacity, full bar, ambiance and other qualities ranging from valet parking to gluten free menu availability.

Creating affiliate programs with the travel industry and restaurant-related websites to increase sales and visibility;

These and other objectives and advantages of the invention are achieved throughout this novel method hosted in a single portal on a server, which contains all of the programming for restaurants and consumer access, storage and retrieval of information. The drawings below illustrate and show by example the critical aspects of this invention.

### 4. DETAILED DESCRIPTION OF THE INVENTION

The restaurant industry and other similar industries are not maximizing the full potential offered by Internet commerce. In response to this need, the Pre-Fixe.com Invention Method includes a system through which such industries can sell goods and services online through a single industry dedicated web-based portal where they can sell the custom designed Suite of E-Products comprised of E-Gift Certificates, Customized Event and Group Dining Software, Ongoing Pre-Fixe™ Menus and Pre-Fixe™ it Menus, Special Offers, plus proprietary software such as the All-Inclusive Dining Calculator and an enhanced industry filter search.

The Pre-Fixe.com Invention Method includes online storage and retrieval of credit purchases by consumers through a seamless, paperless, green alternative that replaces the traditional print paper or magnetic gift cards or certificates currently in use. Beginning with the Restaurant industry, our invention provides the ability for merchants to create automated promotional custom mini-websites within the portal and which are hereby referred to as “Microsites”. These Microsites include custom shopping carts also viewed from each merchant's own websites via a link provided by the Pre-Fixe.com System Method. The Pre-Fixe.com Invention Method allows consumers to perform conventional searches by merchant name, location, mile radius and cuisine to find the merchants that fit their criteria. This method allows consumers to fine tune their search by E-Product availability and by the Pre-Fixe.com custom designed Features & Services Icons, which are also search filters.

Upon the search criteria being selected, consumers are taken to the Search Results Page where consumers can use the E-Gift Certificate Quick Buy Feature to make purchases.

Upon a merchant agreeing to the Pre-Fixe.com Merchant License Agreement, the sale of E-Gift Certificates is activated at the Search Results Page and the E-Gift Certificate Button is illuminated throughout the Merchant Microsite. At this point, the Invention Method prompts the merchant to create a link to the E-Gift Certificate shopping cart directly on that merchant's website. The Invention Method generates an email to be sent to the merchant's webmaster which includes the code needed to activate the link to begin selling E-Gift Certificates to consumers directly from that merchant's website.

Through the Pre-Fixe.com System Method and software, merchants can also sell through the E-Gift Certificates button that appears throughout the Merchant Microsite.

Upon clicking the E-Gift Certificate button, consumers enter the merchant store. On this page consumers can chose an amount either through a drop down window of pre-set amounts or by entering any denomination. Consumers can also make purchases by multiplying the average price per person times the number of people being hosted. In addition, the consumer has the option to purchase multiple E-Gift Certificates of any amount and at different merchants for different recipients, and proceed to customize each E-Gift Certificate with messages and/or images.

Once a merchant has agreed to the Merchant License Agreement and the E-Gift Certificates button is activated for online sales, merchants are prompted to enter into the All-Inclusive Calculator area where merchants post specific pricing information to help increase each sale while allowing consumers to more accurately estimate the total cost of dining at a particular merchant. The All-Inclusive Dining Calculator includes allowances for.
The average dining price per person times the number of people being hosted
The average price of a wine bottle times the number of bottles
The corkage fee per wine bottle times the number of bottles
The average price for a well or brand name cocktail times the number of cocktails and/or a beverage allowance open field
A merchant recommended gratuity percentage or a gratuity percentage open field
The city's sales tax percentage

Pre-Fixe.com DOES NOT COLLECT SALES TAX, AND ALL AMOUNTS CALCULATED ARE ESTIMATES ONLY and dollar for dollar credits for any goods and/or services offered at the merchant's establishment.

Through Pre-Fixe.com merchants can also sell through the Event & Group Dining button that appears on all of the merchant pages.

The System Method allows the merchant to download software that helps merchants and consumers with Event & Group Dining. For the merchants, posting the group menus online saves them expensive employee time and money in printing, mailing and phone calls, Through Pre-Fixe.com consumers can do their research online, plan ahead, pre-pay, personalize and send their chosen menu online to the merchant ready to print and display at the group event. In this area of the Invention Method's portal, merchants can post three distinctive kinds of group menus:
Group Pre-Fixe™ Menus are price fixed group menus that provide an array of choices for appetizers, main courses, desserts and specific wine selections, so that consumers can easily build their own group Pre-Fixe Menu and give their guests specific number of choices per category.
A la Carte Group Menus feature individually priced menu items by category to allow consumers to build their own, custom A la Carte Menu by adding each item to obtain the final price per person.
Chef's Choice Group Menus consist of uploaded images of seasonal tasting group menus previously chosen and priced and available for purchase online.

For the consumer the System Method allows the organizer to select their group menu. The new and uniquely designed Pre-Fixe.com Event and Group Dining Software allows consumers to personalize the menu with a message and/or an image, share the menu with others in the group and invite guests from their email contact lists through the following actions:
Import contacts from a CSV file
Import contacts from public domain sites such as Gmail, Hotmail, Yahoo, AOL, etc
Cut and paste from established groups on a contact email database
Generate an automated email from a private domain on a computer-based program such as Outlook contact list, which is a unique feature of the System Method. Such email contains a link that takes guests to Pre-Fixe.com where they need to register to view the invitation. This process populates the organizer's Pre-Fixe.com guest list automatically
Pay in one payment, or issue separate checks to allow guests to pay for their portion of the meal, or their subgroup
Send the customized menu to the merchant ready to print

Through our System Method, merchants can activate the sale of price fixed menus through the Pre-Fixe™ Menu button that appears on all of the merchant pages.

Here, the invention promotes and encourages merchants to sell two distinctive types of price fixed menus:
Ongoing Pre-Fixe™ Menus are multi-course meals at set prices offered by the merchant on a regular basis at their location. Merchants can upload imagew of the menus and enter prices into their Pre-Fixe.com Microsite so that consumers can pre-pay for them online.
Pre-Fixe It™ Menus are the Pre-Fixe.com proprietary, further discounted price-fixed menus that offer additional value to consumers and are available only with pre-payment at Pre-Fixe.com subject to the terms and conditions specified by the merchant.

Through Pre-Fixe.com merchants can also sell through the Special Offers button that appears throughout the Merchant Microsite.

This area of the Merchant Microsite gives merchants full control to promote Special Offers on their own terms, on specific dates, and any time. To activate a Special Offer, merchants can choose and customize from a list of sample Special Offers, or post their own. The System Method allows merchants to set the specific dates when the offer is available through the Pre-Fixe.com calendar. Merchants can also limit the number of offers and add their own terms and conditions or by choosing from a sample form provided by the System Method.

Through Pre-Fixe.com consumers can choose to receive news and specials by entering their name and email on the home page. Pre-Fixe.com visitors do not need to register nor create an account to navigate. In order to make a purchase, receive an E-Gift Certificate or sign up to attend an event, visitors must register and create an account. Once an account has been created, consumers can access the My Account area via the Log In button.

Consumers receive email notifications of all activities posted to their account. The System Method generates a sales confirmation by email sent to merchants, purchasers, E-Gift Certificate recipients, and the Pre-Fixe LLC™ Administration. Purchaser has the option to include an instant and/or later scheduled email notification to alert a recipient of an E-Gift Certificate and/or a guest, of a planned event. The System Method also stores historical sales and purchase logs with different views that are customized for the Pre-Fixe.com Administration, the merchant, the recipient and the consumer/issuer in the My Account area of the System Method.

The Log In link is the area where users can create an account and subsequently log in. There are three distinctive users who can manage different types of accounts:
Pre-Fixe.com Administrators have access to:
   My Account
   Invite a Friend
   Manage Page Content
   Create an Ad
   Manage Ads
   Manage Email Templates
   Manage Restaurants
   Manage Advisory Board
   E-Products
   Manage Users
   Events & Group Dining
   Accounting/Billing
   Manage My Profile
   Logout
Restaurant Administrators have access to:
   My Account
   Invite a Friend
   Manage Restaurants
   E-Products
   Manage Users
   Events & Group Dining
   Accounting/Billing
   Manage My Profile
   Logout
Consumers have access to:
   My Account
   Invite a Friend
   E-Products
   Manage Users
   Events & Group Dining
   Accounting/Billing
   Manage My Profile
   Logout

Combination Users who fall into more than one of the above categories have access to several of the above-listed privileges depending on their status and permissions issued by Pre-Fixe.com.

Each sales transaction is assigned a purchase order number by E-Product category. No printing is necessary. Upon redemption wherein the merchant verifies the purchase order number and proper identity of the user to deduct the used amount from the current balance. Consumers can consolidate/merge amounts of different purchase orders and create a new E-Gift Certificate for easier redemption or re-gifting within individual merchant balances only. Balances between different merchants cannot be combined.

The Invention Method includes a merchant program that allows them to reward customer loyalty at any time through credits and/or a discount code placed by the merchant onto the System Method's consumer created account or sent through an email.

The Invention Method allows merchants to post specific terms and conditions for any of the E-Products offered through their Microsite.

If a merchant participates in the Pre-Fixe.com portal, it receives a complimentary Microsite that includes the following:
An editorial page that gives the merchant additional online presence including merchant's primary contact information visible from various Merchant Microsite pages and includes: the business name and logo, the physical address and cross street, the cuisine, the telephone number, the fax and reservation link (if any), the email address and links to their website, map, menu pages, a slide show of merchant's images, an informative written description of the merchant's business, icons that showcase and facilitate searches by merchant features, services and E-Product availability, links to social media pages, reviews and press releases and unique images and biographies of key personnel.
An automated shopping cart activated in the results page as a Quick Buy feature, and on all of the pages of the Microsite accessible through the E-Product buttons. Merchant activated E-Product buttons are illuminated; if such products are not available, the buttons are dimmed.

Up until now, the Restaurant industry doesn't have a single venue where online generated E-Gift Certificates and other custom E-Products can be sold. To fill this need, the Pre-Fixe.com is a solution that brings the industry together to create a one-stop shopping venue.

Currently most merchants can sell either printed gift certificates or magnetic gift cards. These are sold over the phone and/or in person and at times online. merchant personnel must issue the gift certificate by either printing the certificate or issuing a magnetic gift card. Either form of these gift certificates then needs to be physically delivered to the recipient. Consumers must provide their payment information over the phone, in person or by filling out forms that need to be physically mailed, faxed or submitted online.

Traditional gift certificates and magnetic cards have limitations when it comes to refunding unused credits. Magnetic gift card limitations include refunds by fixed amounts, forcing merchants to make cash refunds. In addition, there is high risk of loss and/or theft by unauthorized users.

The Pre-Fixe.com Invention Method uses green technology to fully automate the sale, utilizing email as the send and receive venue and includes an automated credit storage system that stores and maintains balances without the need for any cash refunds. The electronic maintenance of the credit database in a secure server with password protected authorized user identity diminishes the probability of loss, unauthorized use or theft of a printed certificate or a magnetic card.

The initial focus of Pre-Fixe.com is to target the top tier of the restaurant industry. Pre-Fixe.com surveyed 100 Northern California restaurants in 2011 and found that 25% of such restaurants were selling magnetic gift cards online and none were found to sell online gift certificates from their own websites. The Invention Method expands online sales capabilities by activating the sale of E-Gift Certificates, which is a green alternative.

The Invention Method expands merchant online sales to state-of-the-art E-Gift Certificate sales for gifts to others, while creating other online sales opportunities by the invention of the Suite of E-Products. The Suite of E-Products allows consumers to also make online purchases for their own use and for groups. The All-Inclusive Sales Calculator helps increase sales for the merchant while enabling consumers to estimate an approximate amount of the cost of dining at a particular merchant.

The Pre-Fixe.com Invention Method includes an affiliate program that disburses commissions to incoming affiliates. This program is designed to allow other portals to add a link to Pre-Fixe.com and begin making a percentage on the online sales the Pre-Fixe.com Suite of E-Products that originates at the Affiliates' websites. Pre-Fixe.com plans to sell the affiliate program to other online Restaurant guides and reservations systems, and to the travel engines currently selling for the airline, the transportation and the hotel industries.

There are portals that provide the Restaurant industry specifically with services that are complimentary to the Invention Method and who could become Pre-Fixe.com incoming affiliates. Some examples are:
Open Table provides restaurants with online reservation system and floor plan management software that is complimentary to the Pre-Fixe.com method.
Zagat, Gayot & Gaut et Millau Restaurant Guides are world-renowned guides filled with information on restaurants which are complimentary to the Pre-Fixe.com System Method.
Travel engines such as Trip Advisor feature a restaurant tab with consumer comments and could also become a Pre-Fixe.com affiliate.
All other travel engines selling airline tickets, car rentals and hotel accommodations are potential Pre-Fixe.com affiliates.

Other portals with similar technology are:
Magnetic gift card companies—some of which offer online gift certificate software and sell this technology primarily to chains and printing may still be required.

Pre-Fixe.com will not sell magnetic gift cards and will focus on the Suite of E-Products that includes the online sales and management of the Suite of E-Products for whole industries at a time.
Deal-of-the-day sites such as Groupon and LivingSocial are websites that offer an array of discounts to consumers in a variety of industries for a limited time only. Offers are sent by email to subscribers providing a single marketing, deeply discounted sales opportunity for participating merchants and often at a loss for the merchant attracting one-time deal seekers unlikely to return.

The Pre-Fixe.com Invention Method includes an area on the Merchant Microsite, which allows merchants to post and sell Special Offers on their own timing, terms and conditions. This area of the Invention Method is designed to fill tables during off peak hours and help merchants increase revenues and profitability on an ongoing basis and attracting a following of loyal customers.
Restaurant.com is a restaurant portal that sells deeply discounted gift certificates that must be printed for redemption, typically focusing on lower and medium tier restaurants. Pricing and redemption are at the full control of Restaurant.com. For example a $25 gift certificate can be sold on their website for as little $2.00, which can adversely affect a merchant's overall image and value perception.

Our Invention Method allows merchants to sell E-Gift Certificates and an entire Suite of E-Products at face value, giving merchants full control over each of their online offerings. Pre-Fixe.com will focus on the top tier of the Restaurant industry.

### 5. NETWORK OPERATING ENVIRONMENT

The present invention is implemented within a data communications network of interconnected codes that support the System Method and consistent with the present invention which are connected to a server, such as a Local Area Network, Wide Area Network, or the Internet. The server used currently is hosted at Host Monster.com and in the future it may be moved to a dedicated server. The user and merchant computer system must also connect to the Internet in order to access Pre-Fixe.com.

### 6. BRIEF DESCRIPTION OF THE DRAWINGS

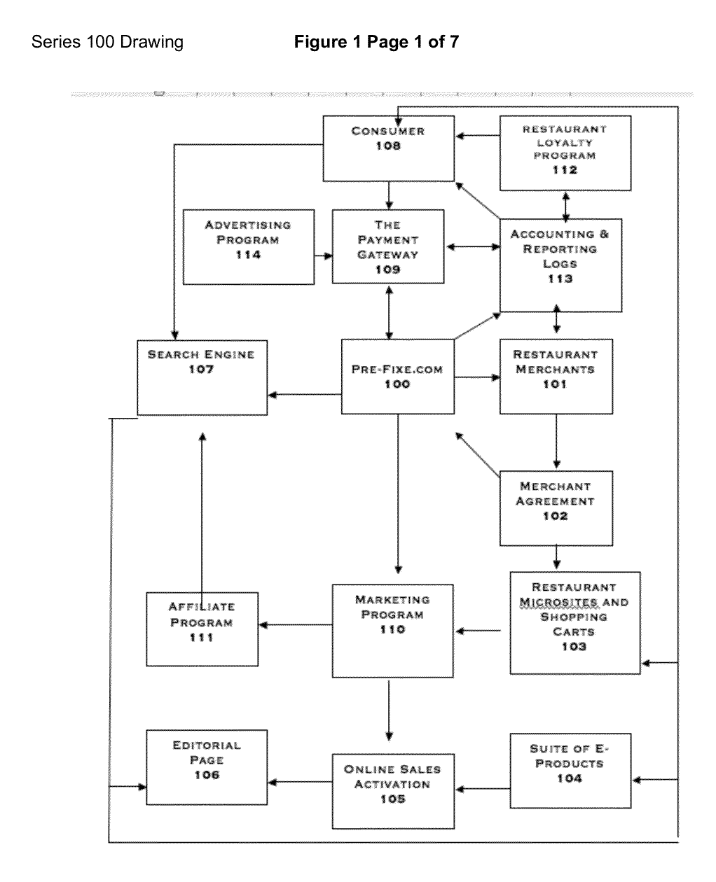

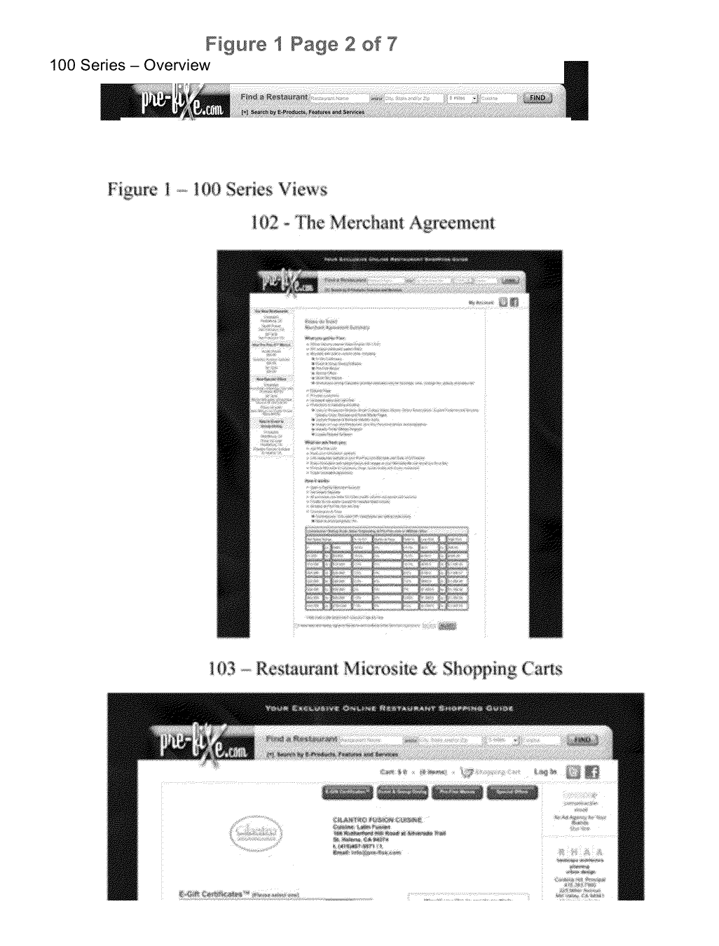

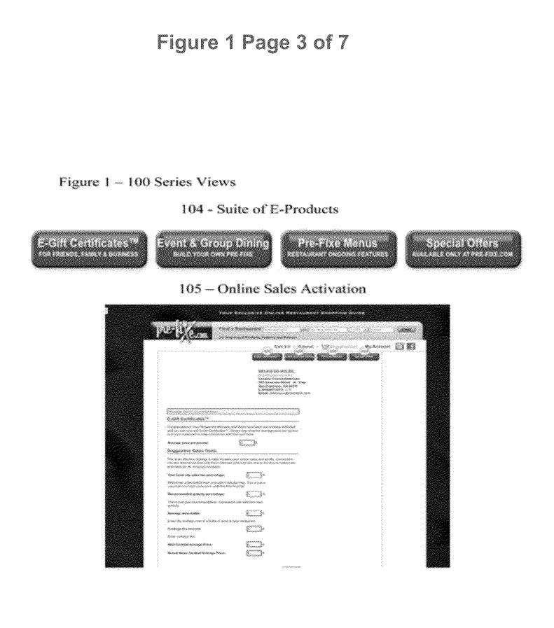

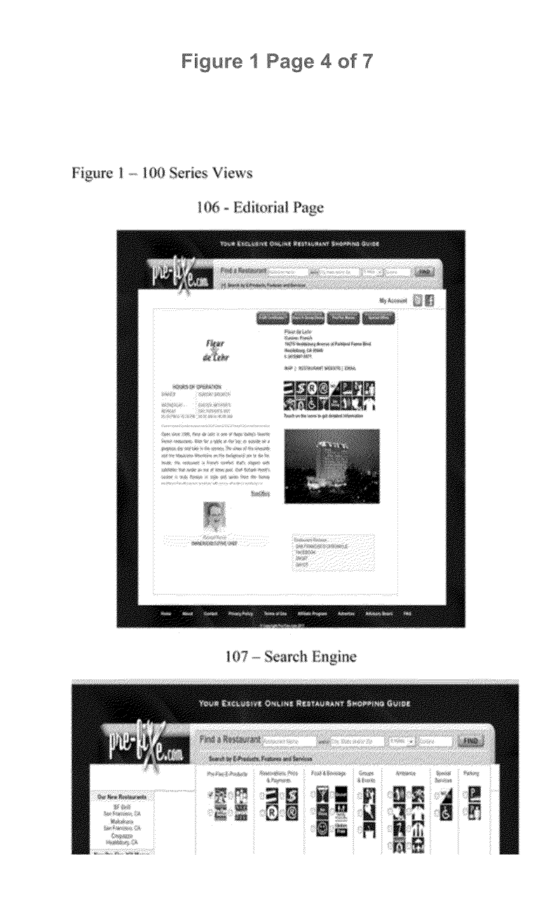

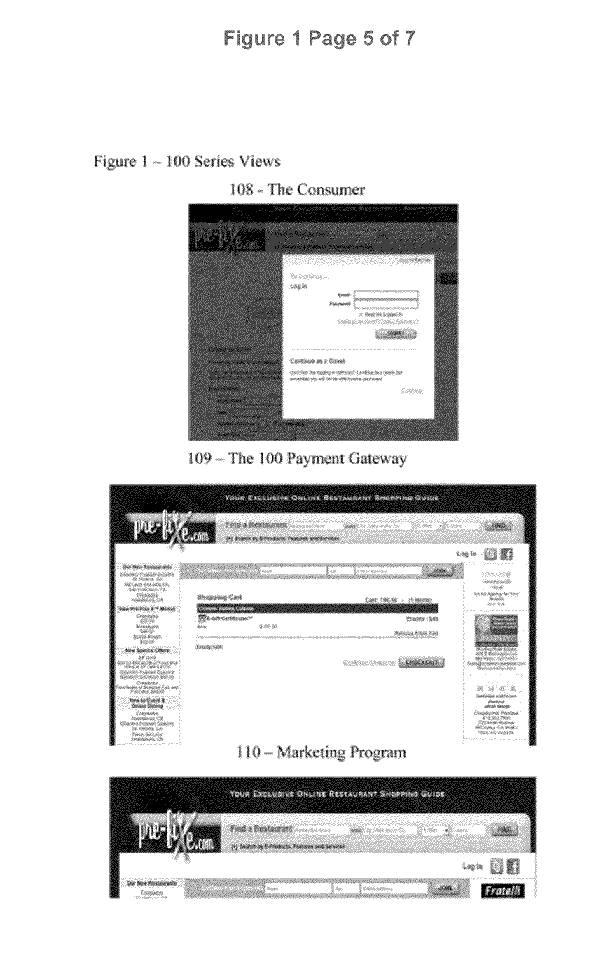

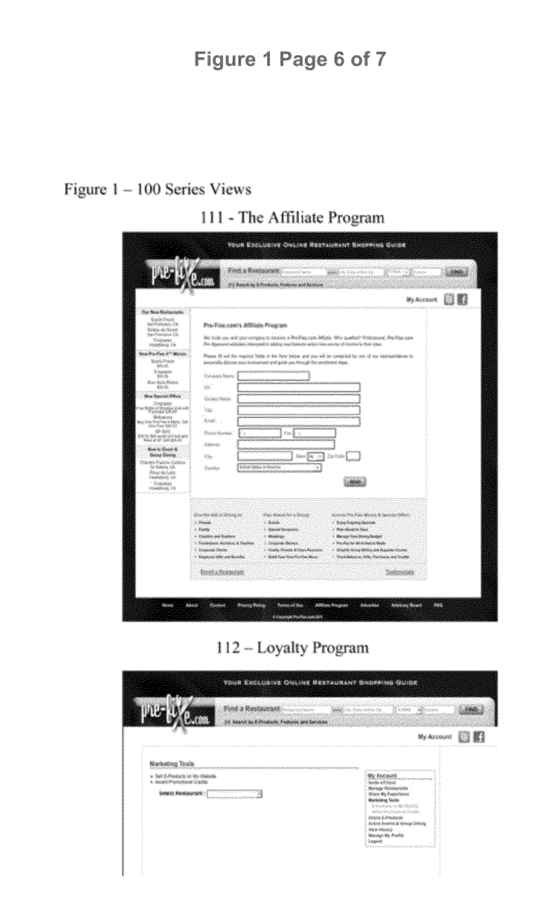

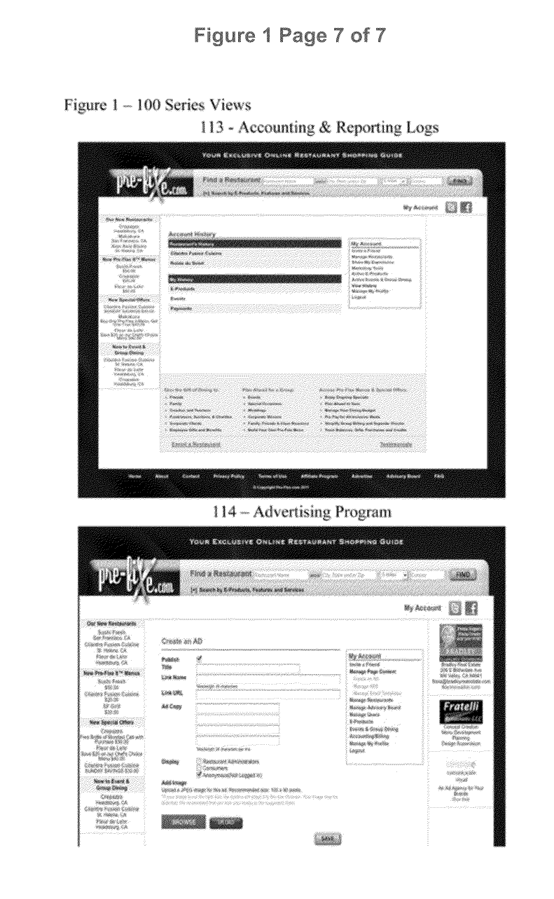

Series 100—Overview—FIG. 1—Page 1 of 7

100—Pre-Fixe.com—(hereinafter referred to as either “100” or “Pre-Fixe.com”) is the online industry Portal and software featuring pre-selected merchants (“101”) who are invited to join and follow the steps further described in this document. FIG. 1 Page 2 of 7

101—Merchants—are the merchants selected and invited by 100 to join the network, upload information and sell their goods and services online and through 100's gateway.

102—Merchant License Agreement—is 100's contract that lists the terms and conditions between 100 and 101. Upon 101 agreeing to 102 through an online virtual signature, the System Method allows 101 to upload information and immediately start selling online. FIG. 1 Page 2 of 7

103—Merchant Microsites & Shopping Carts—are 101's custom mini-websites located at 100. FIG. 1 Page 2 of 7

104—100's Suite of E-Products—are the goods and services that 101 can sell from their own website and at 103. 100's E-Products customizes online sales by providing online forms with fields for the merchant to enter 101's average pricing of their goods and services to help consumers calculate the cost of dining at 101 and make online purchases. This allows merchants to receive payments prior to providing the goods and/or services to the consumer and helps 101 with their cash flow. These E-Products will be listed individually and further described in Section 200. FIG. 1 Page 3 of 7

105—Online Sales Activation—is the instant result of 101 agreeing to 102 and creating 103 by entering some or all of the information described in 104. FIG. 1 Page 3 of 7

106—Editorial Page—is a promotional page composed of the merchant primary contact information which includes: name of merchant, physical address and cross street, neighborhood, phone number, fax numbers, email, cuisine, any online reservation information and links to 101 website, menus and map. 101 is prompted to activate the Features & Services industry icons and search filters to showcase their unique facility qualities, ambiance, noise level, average pricing and display their offerings on the page to facilitate the search process. 101 can also upload images of their logo, their establishment and key personnel, enter an informative write-up about their establishment, biographies and titles of key personnel and link 103 to reviews in magazines, newspapers, online venues and their own social media pages. FIG. 1 Page 4 of 7

107—Search Engine—100's Search Engine allows visitors to search by conventional searches such as geographical location, merchant name and cuisine, and through industry-specific filters unique to the System Method. FIG. 1 Page 4 of 7

108—The Consumer—is a guest/visitor to 100 who can browse and search for 101's by utilizing 107 and who must become a registered user to make a purchase, receive an online gift or accept an invitation to an event. FIG. 1 Page 5 of 7

109—The 100 Payment Gateway—is 100's payment process managed by a third party. This area of the portal is where 108 makes payments of chosen E-Products at the selected Microsites allowing multiple payments at several merchants at one time. The third party payment gateway instantly splits and distributes each purchase amount between 100, 101's and 109's transaction fees and commissions. FIG. 1 Page 5 of 7

110—Marketing Program—consists of mass email campaigns, industry event publicity and public relations, a 100 maintained blog and social media pages, 101's websites and through a smart phone application. Consumer's sign up to receive news and specials through a prominently displayed field on the home page and other main pages of 100. FIG. 1 Page 5 of 7

111—affiliate program—creates incoming and outgoing affiliations with other portals to increase visibility and sales. Incoming affiliates earn a commission for every sale at Pre-Fixe.com that stems from its website. Outgoing affiliates consist of 100 joining a third party affiliate program that pays a commission to 100 when a sale of their products originates at 100. Affiliations are created through code that activates links on each other's websites. FIG. 1 Page 6 of 7

112—Restaurant Loyalty Program—allows 101 to issue promotional credits and/or discount codes to their customer base. FIG. 1 Page 6 of 7

113—Accounting & Reporting Logs—is the part of the Invention Method that stores, manages and issues reports on purchases, balances and credits for 100, 101 and 108. FIG. 1 Page 7 of 7

114—100's Advertising Program—a program unique to the Invention Method that charges 100's advertisers one cent per day for every merchant that joins 100 during its first year of operation. 114 has four kinds of banner ads: 1) A Back End Banner that is only visible to 101 and enables 114 to promote their brands, offer special pricing and advertise directly to 101's, 2) A Registered User Banner that is visible only by 101 registered consumers, and 3) An Anonymous Banner visible to non-registered consumer visitors. 4) 114 can choose from one or more of these three options. FIG. 1 Page 7 of 7

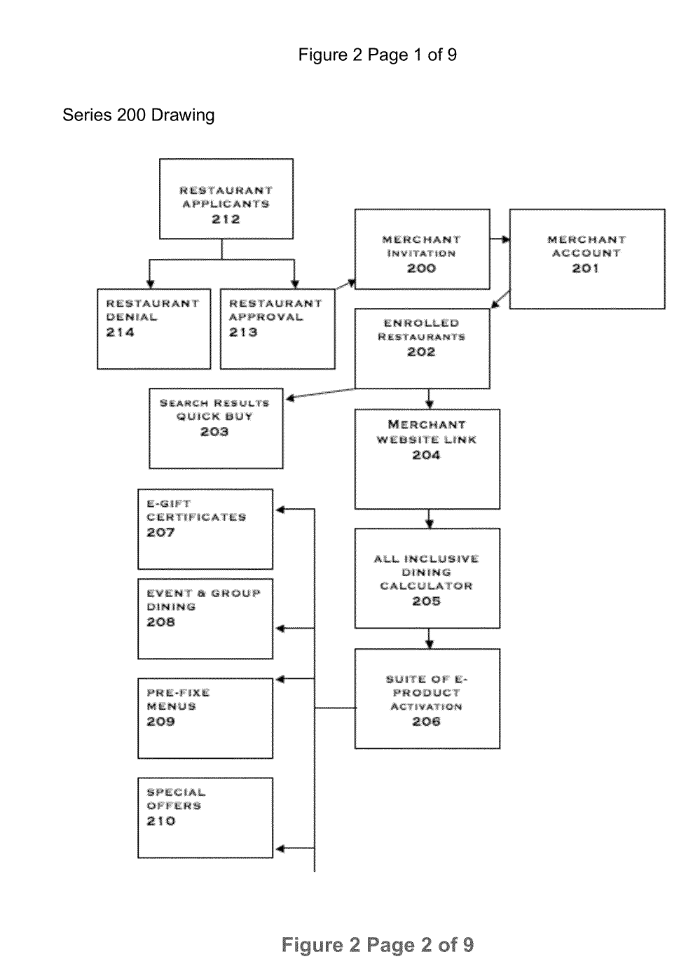

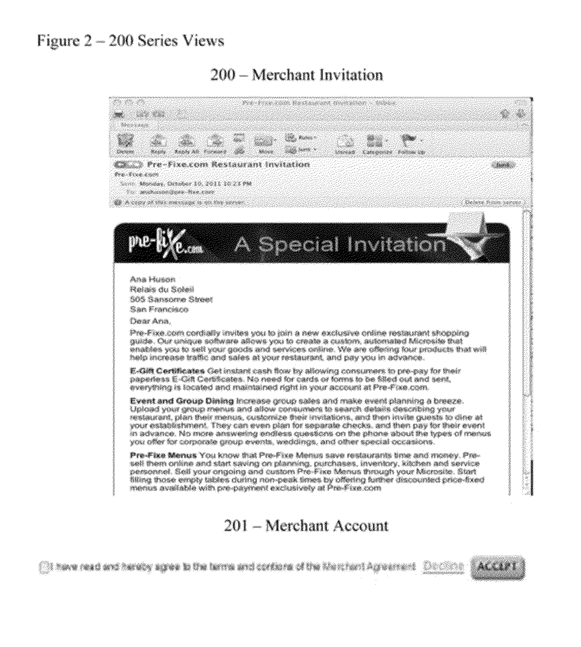

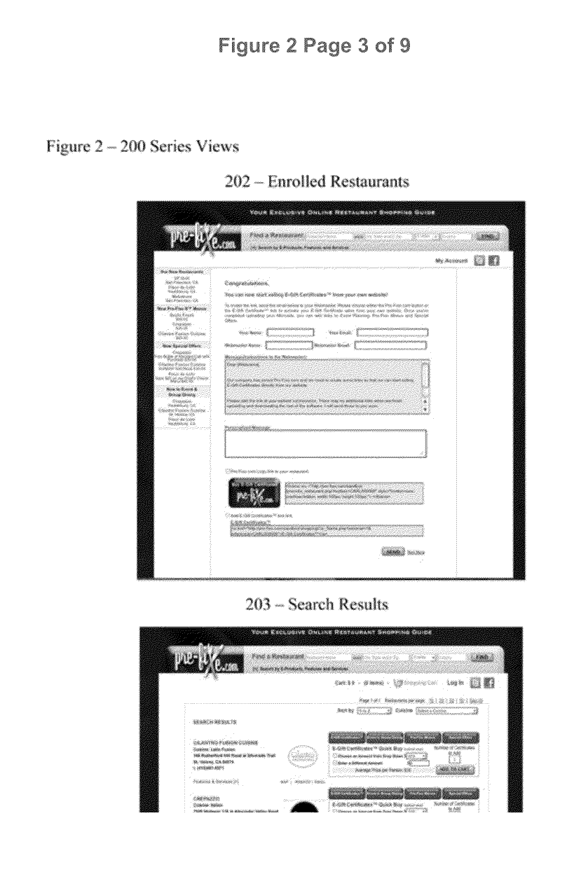

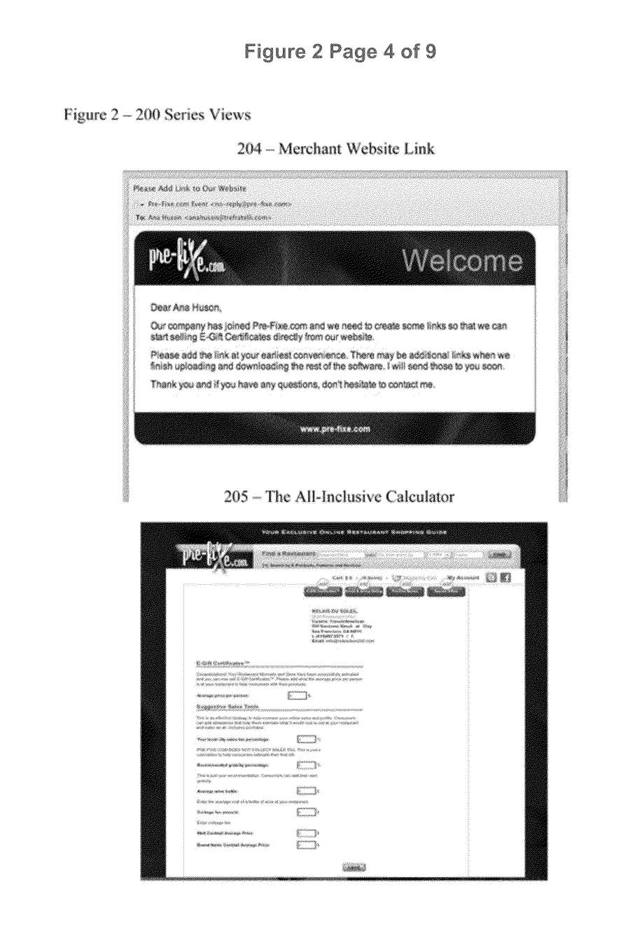

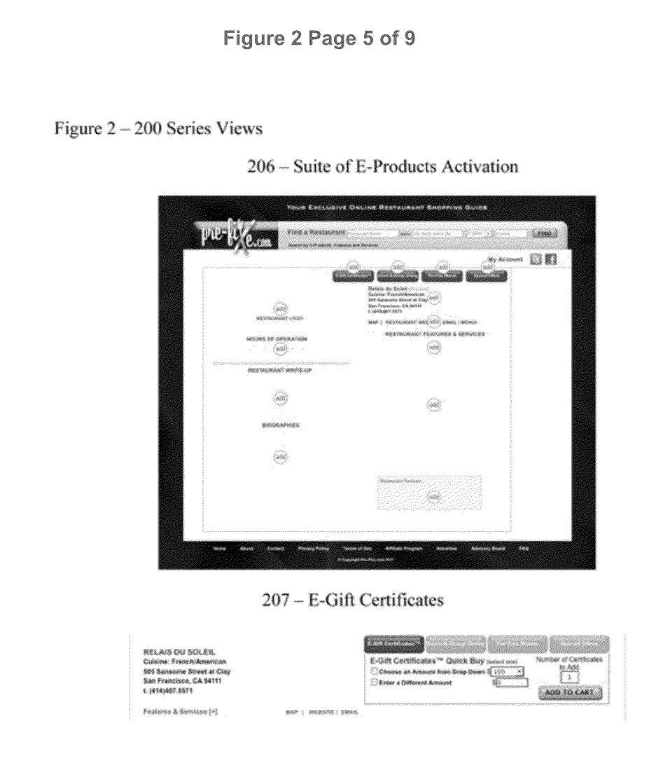

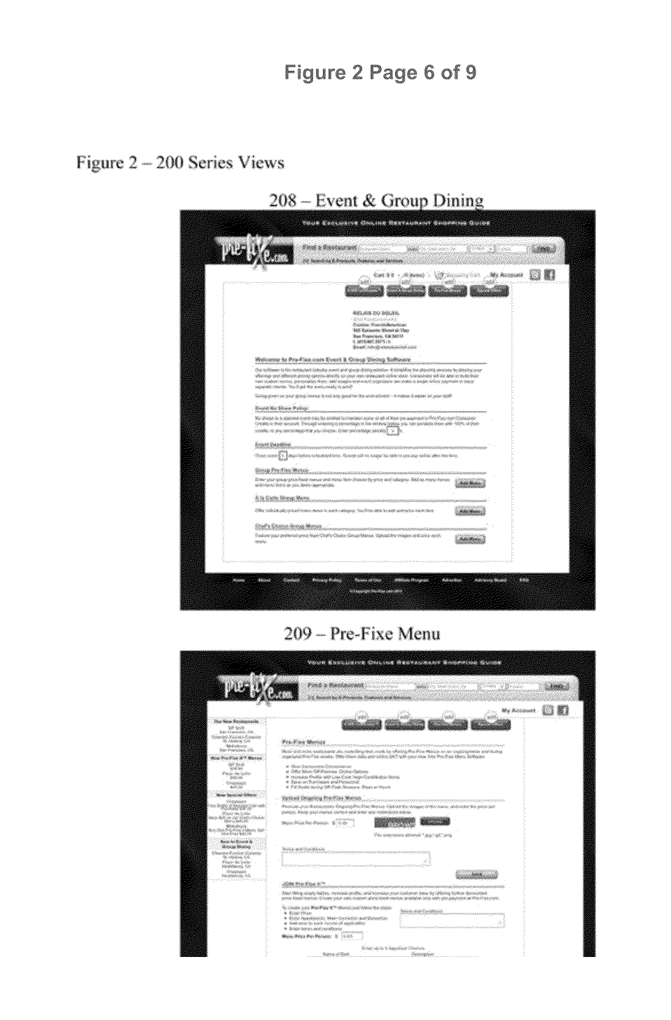

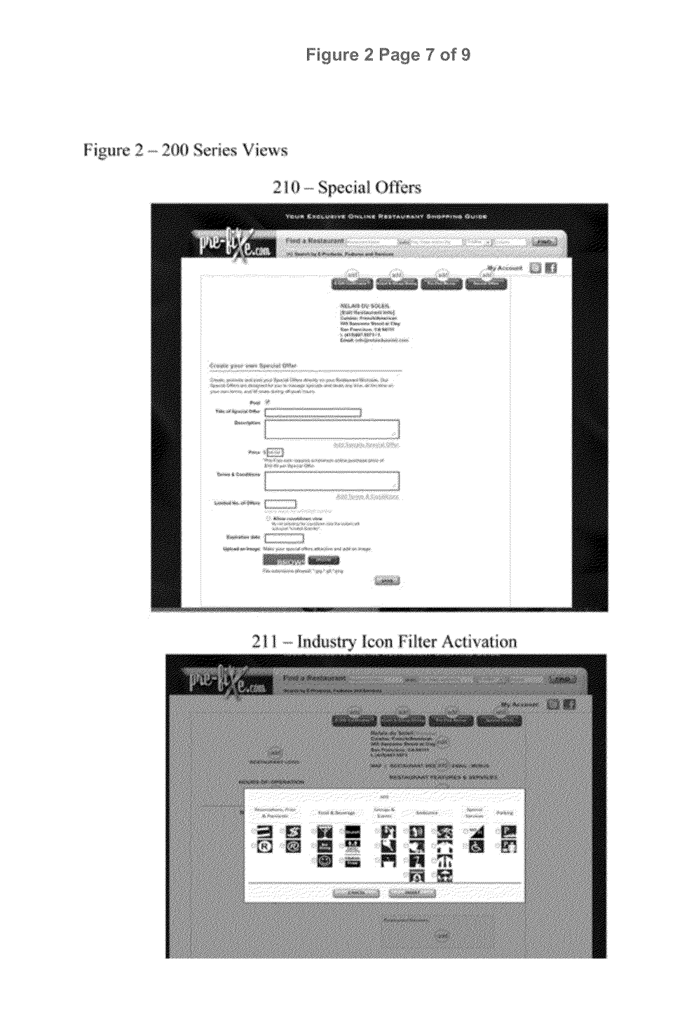

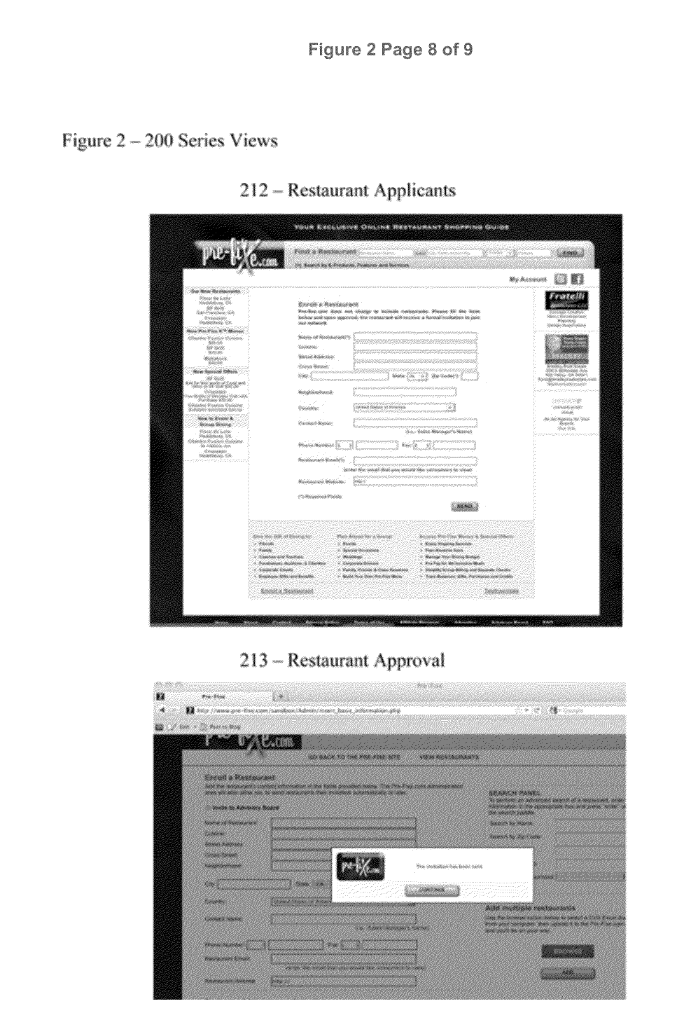

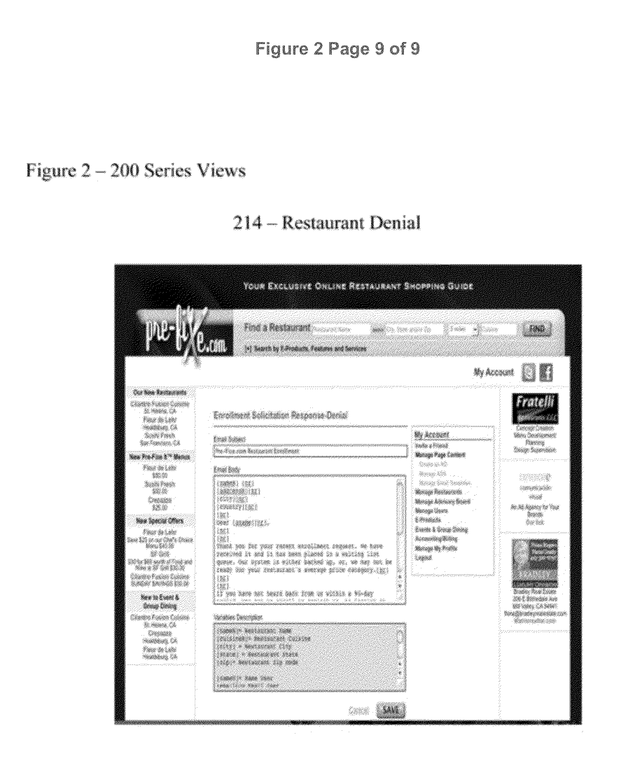

200 Series—The merchant Experience—FIG. 2 Page 1 of 9

200—Merchant Invitation—is sent by pressing the “send now” or “send later” buttons. The System Method saves the date and time each invitation is sent to help 100 monitor responses and/or re-send the invitation if needed. merchant primary contact information is entered individually or exported in groups from a CSV file. 100 can invite several merchants at a time. FIG. 2 Page 2 of 9

201—Merchant Account—is created through a form provided by the 109. Once 101 has created 201, that information will be the “ID” used for all transactions. 202—Enrolled 101's—are 101's who have created a 201. FIG. 2 Page 3 of 9

203—Search Results Quick Buy—is activated by 202's who can instantly begin online sales of E-Gift Certificates directly from the Search Results page and through a drop down of fixed amounts, or through a field provided to enter any denomination. FIG. 2 Page 2 of 9

204—merchant Website Link—produces an email with the code that 202's webmaster needs to create a link to 103 at 202's website. The System Method allows 202 to send the email immediately or postpone it for a later time. The System Method stores the links to all of the E-Products for future access and activation. FIG. 2 Page 4 of 9

205—All-Inclusive Dining Calculator—is a suggestive sales tool that follows an E-Product purchase selection to help increase the total amount of the sale for 202 while helping 108 estimate the cost of dining at each particular Restaurant. The System Method issues allowances for each selected category and 108 can choose to utilize the calculated amount, use the “round off to the nearest ten” tool provided by the System Method, or simply enter their own amount. FIG. 2 Page 4 of 9

Through this area, 202 enters the following general pricing information:
1. The average price per person for dining at 202
2. The average price of a bottle of wine
3. The corkage fee
4. Recommended gratuity
5. Sales tax
6. The average cost of a well cocktail and a brand name cocktail

PRE-FIXE.COM DOES NOT COLLECT SALES TAX AND ALL ALLOWANCES CALCULATED BY 205 ARE ESTIMATES ONLY. All purchases are dollar for dollar credits at that particular 202, valid towards any goods and/or services 206—Suite of E-Product Activation—is comprised of a series of steps issued by 100, which requires 202 to enter pricing information, upload menus and menu items by each of the E-Products listed below. As soon as each area is populated with the required information, the corresponding button is illuminated, alerting 108's of the E-Products that are available at a particular merchant. If a 202 has chosen not to activate a particular E-Product the System Method shows the corresponding button as dimmed. 100's System Method includes a search filter that allows 108 to search by E-Product availability. FIG. 2 Page 5 of 9

207—E-Gift Certificates—are paperless online gift certificates purchased by 108 and emailed to others. Recipients are required to create an account in order to redeem their gift. Once their account is open at 100, they can see and manage their E-Gift Certificate credits. The sales of E-Gift Certificates are offered through two distinct areas: 203 and throughout 103. The button for 207 becomes illuminated upon 101 becoming a 202. FIG. 2 Page 5 of 9

208—Event & Group Dining—allows a 202 to enter group dining information to activate and illuminate the Event & Group Dining button and begin to sell their group menus online. 202 enters group menu information through three distinct categories: FIG. 2 Page 6 of 9
1. Group Pre-Fixe™ Menus—multi-course, price-fixed menus of different price ranges that offer several menu item choices per the following courses:
   a. Appetizers
   b. Main Courses
   c. Dessert

By choosing the menu items by course category, 108 can customize their menu including an image and/or a message.
2. A la Carte Group Menus—list and price multiple items individually within the aforementioned courses. By choosing the menu items by course category, 108 can customize their menu including an image and/or a message.
3. Chef's Choice Menus—existing group multi-course, price fixed menus that can be uploaded as images for 108 to view. 202 then enters the price in the field provided by 100 so that 108 can purchase them online. 108 cannot customize these menus as the Chef has already chosen the items of the group menu.

209—Pre-Fixe™ Menus—are multi-course, price-fixed menus offered on a daily basis or on a specific schedule. 202 can upload these menus on 103 to begin selling them online. The Pre-Fixe Menu button will immediately be illuminated. There are two distinctive types of Pre-Fixe™ Menus: FIG. 2 Page 6 of 9
1. Ongoing Pre-Fixe™ Menus—multi-course price-fixed menus that are already being featured and sold at 202's. To sell them online at 103, they are prompted by the System Method to upload an image of the menu and enter its price.
2. Pre-Fixe™ it Menus are further discounted multi-course, price-fixed menus that are exclusive to and available only at 100 and sold through a particular 103 according to the terms and conditions specified by 202.

210—Special Offers—consist of value-added promotional offers that can be posted at 103. 202 can post a Special Offer at 103 by selecting from several sample Special Offers and sample terms & conditions, or by entering their own. 202 can also upload an image and must enter a title for such offer. Special Offers can be dated, and or have a numbered limit. 202 can choose to display the number of offers available. FIG. 2 Page 7 of 9

211—Industry Icon Search Filter Activation—requires 202 to select the Industry Icons that best describe their establishment. Upon 202 making the icon selection and entries, the icons are uploaded onto 103 and become searchable filters by selecting icons from the following categories: FIG. 2 Page 7 of 9
1. Reservations, Price & Payment Icons to feature:
   a. Major Credit Cards
   b. Major Credit Cards
   c. Reservations Accepted
   d. Online Reservation Program
   e. Average Price per Person
2. Food & Beverage Icons to feature:
   a. Full bar
   b. Bar dining
   c. Happy hour and schedule
   d. Brunch and schedule
   e. Family friendly menu
   f. Gluten free menus
3. Groups & Events Icons to feature:
   a. Wedding Facility Capacity
   b. Private Room Capacity
   c. Conference Facility Capacity
4. Ambiance Icons to feature:
   a. Noise level
   b. Romantic
   c. Live Music
   d. Fireplace
   e. Views
   f. Casual
   g. Jacket Required
   h. Al Fresco Dining
5. Special Services Icons to feature:
   a. Wireless Internet
   b. Wheelchair Access
6. Parking Icons to feature:
   a. On-Premise Parking
   b. Valet Parking

212—Restaurant Applicants—are 101's who have requested enrollment in 100 through the “Enroll a Restaurant” link visible from all of 100's main pages. Other Restaurants or individuals can also submit such an enrollment application on behalf of a Restaurant that they would like to see join 100. FIG. 2 Page 8 of 9

213—Restaurant Approval—upon 100 receiving the Enrollment Application of a particular Restaurant, such application is reviewed by 100's Administration and if approved and at the sole discretion of 100, a 200 is sent to 101. FIG. 2 Page 8 of 9

214—Restaurant Denial—is a system-generated email that is sent to 101 when 212 is not approved by 100's Administration. Such action places 212 on a waiting list for future evaluation by 100. FIG. 2 Page 9 of 9

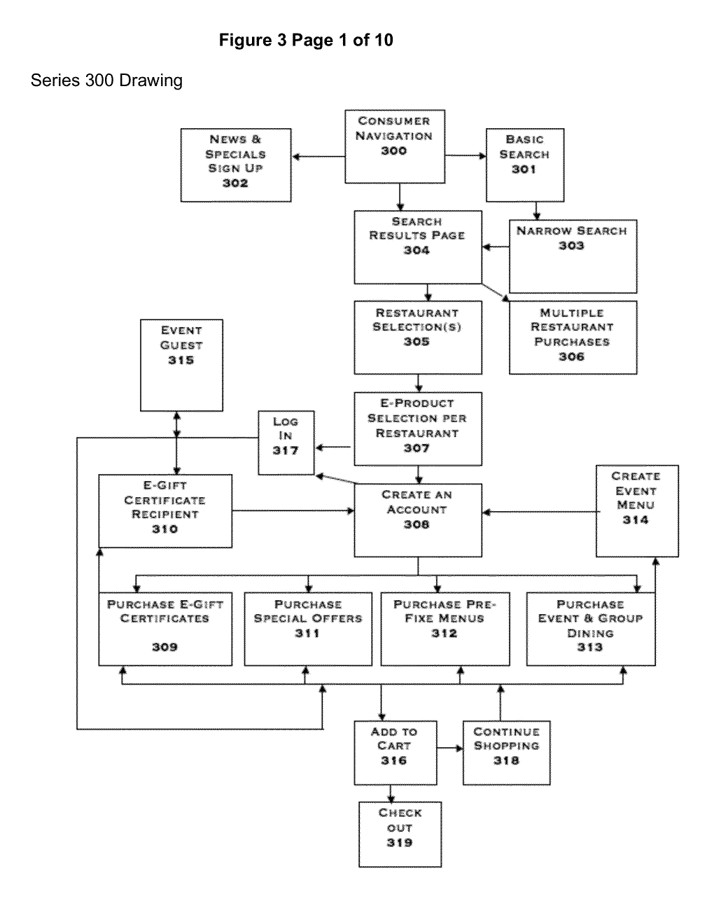

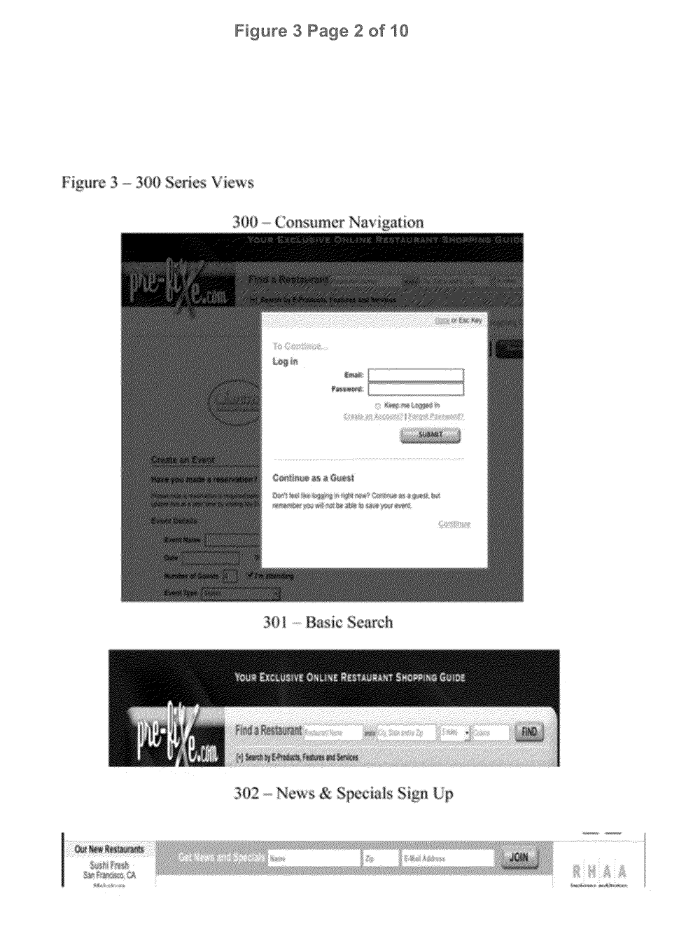

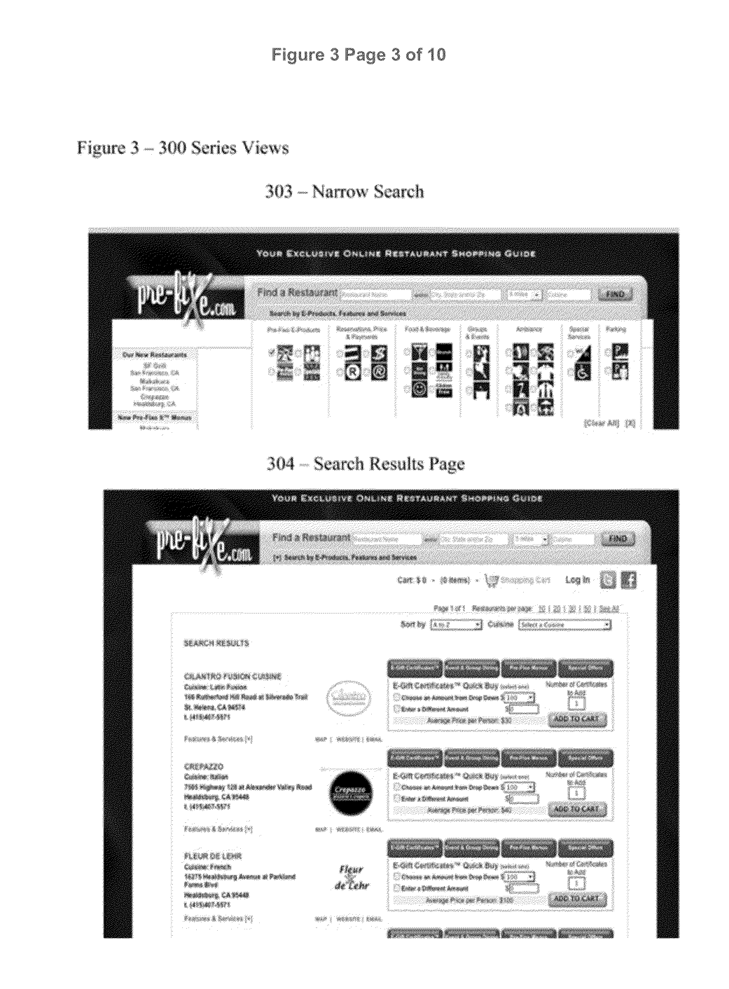

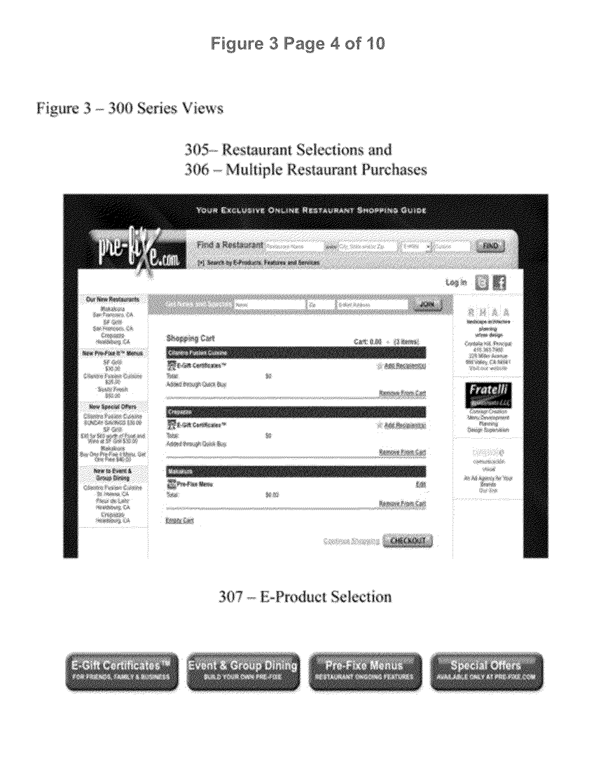

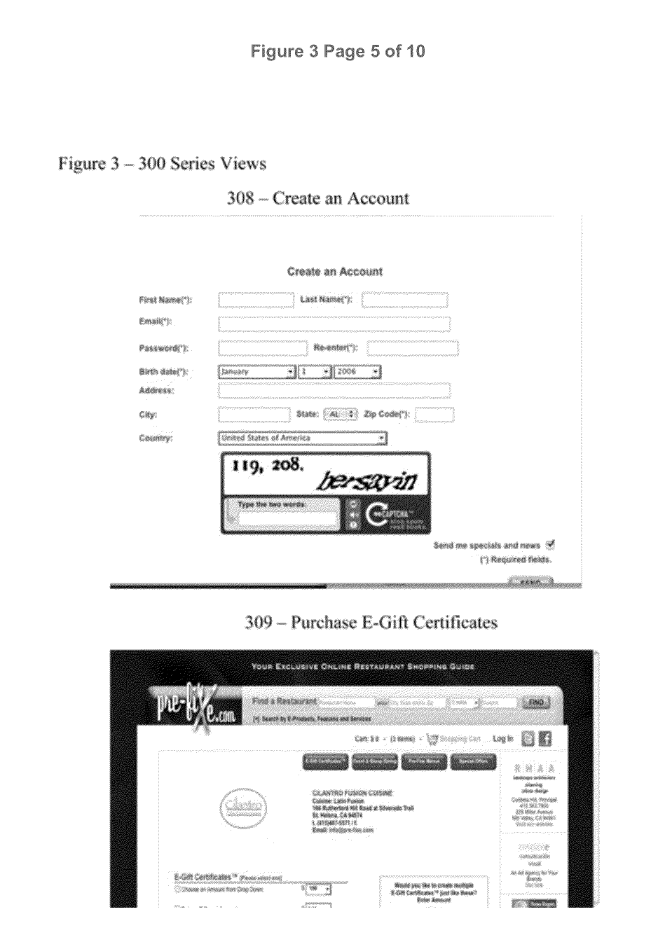

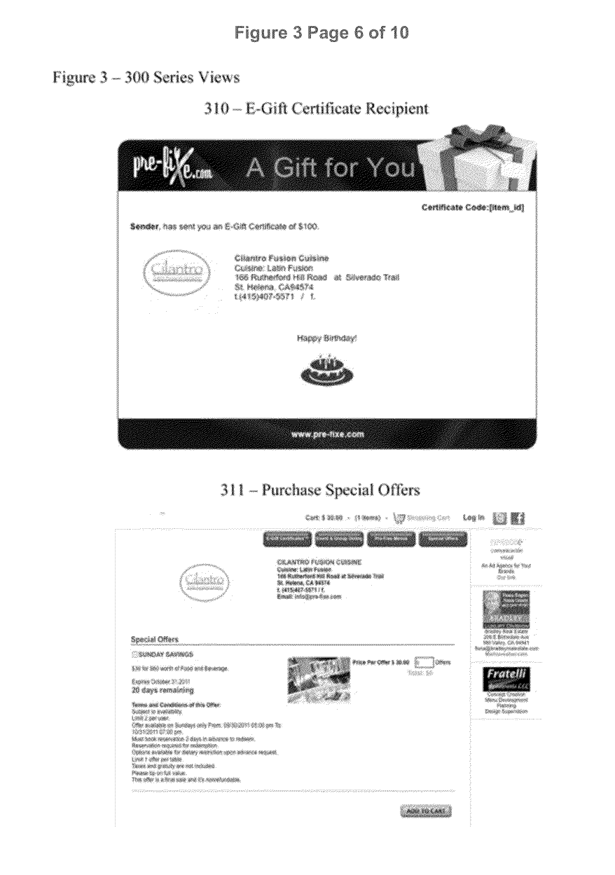

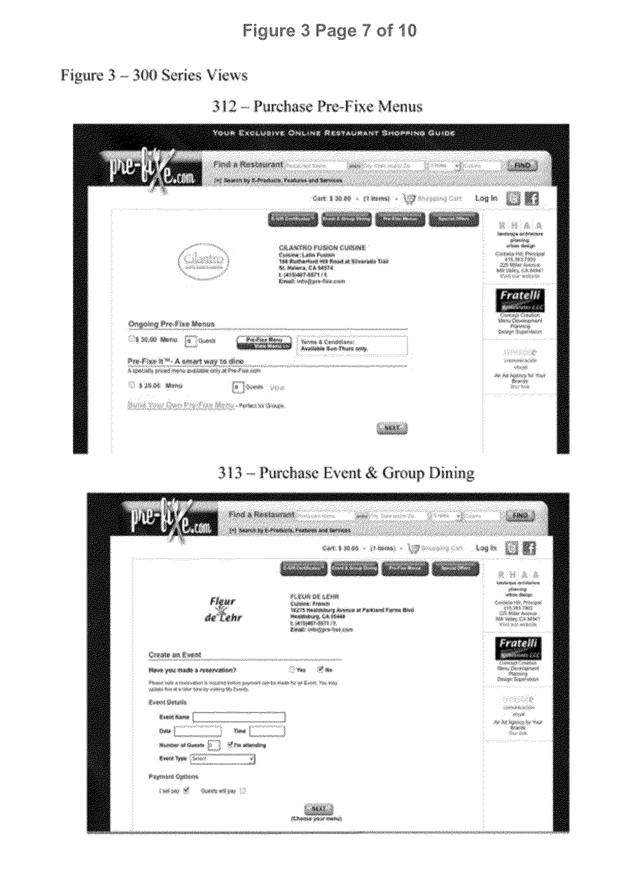

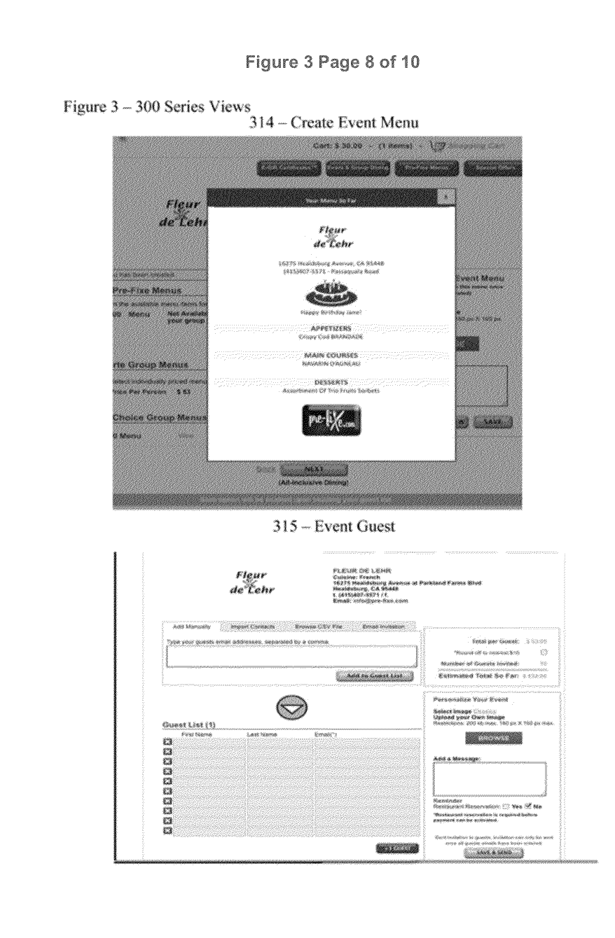

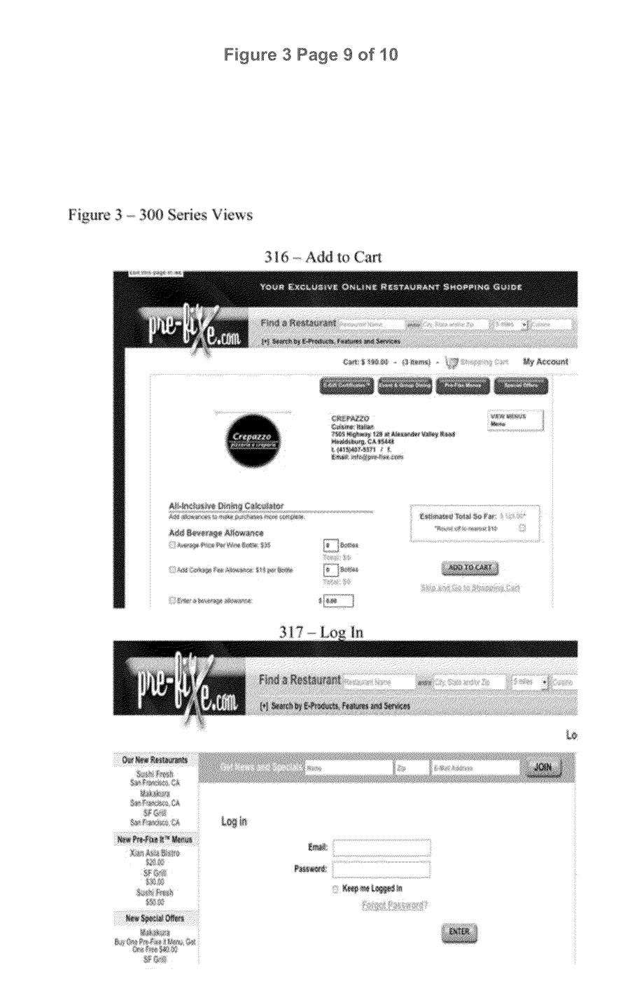

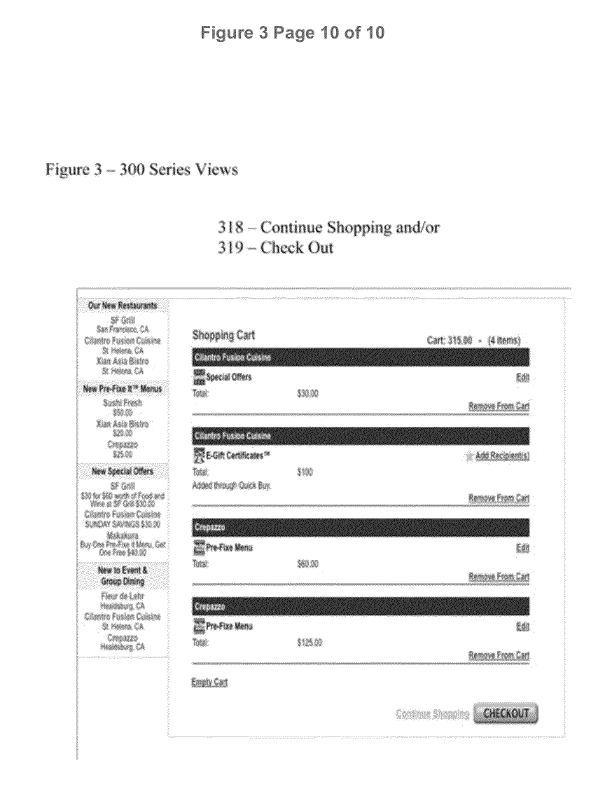

300 Series—The Consumer Experience FIG. 3 Page 1 of 10

300—Consumer Navigation—allows 108 to search, sign up as a Newsletter Subscriber, make Restaurant and E-Product selections, add items to cart and continue to browse through 100 and as a guest, until 108 is ready to make a purchase, confirm attendance or pay for an event, and/or accept an E-Gift Certificate. At this point, they can either create a new account or log in as a Registered User. FIG. 3 Page 2 of 10

301—Basic Search—allows 108 to search by the more conventional filters that include a geographical search by city, state and zip code, mile radius, merchant name and cuisine. FIG. 3 Page 2 of 10

302—News & Specials Sign Up—consists of an area located on the home page and other main pages of this website that allows 108 to sign up to receive our newsletters. By signing up, 108 is authorizing 100 to send them email promotions and campaigns. The email and the zip code are required fields to allow targeting logical geographical areas. FIG. 3 Page 2 of 10

303—Narrow Search—refers to 211 accessible through a link on the home page and all of 100's main pages where 108 can perform a detailed query of his requirements to find 202's that meet 108's criteria. FIG. 3 Page 3 of 10

304—Search Results Page—is the page that showcases the result of a 301 and/or a 303. From this page, 108 can make 203 at one or several 202's. A purchase that is consummated at 304 takes 108 directly to the shopping cart payment area where they can confirm their selections and either continue shopping or proceed to 109. FIG. 3 Page 3 of 10

305—Restaurant Selection(s)—are the 202's that 108 has selected to make purchases through any of the illuminated 104 links. FIG. 3 Page 4 of 10

306—Multiple Restaurant Purchases—allows 108 to make purchases at several 202's and make payments during one visit. FIG. 3 Page 4 of 10

307—E-Product Selection per Restaurant—is the action taken by 108 of selecting an E-Product at a particular Restaurant. FIG. 3 Page 4 of 10

308—Create an Account—is a required action in order for 108 to make a purchase, confirm attendance and/or pay for an event, to redeem and E-Gift Certificate and allow the system to view its historical credit activity at each 202. FIG. 3 Page 5 of 10

309—Purchase E-Gift Certificates—is the action taken by 108 to buy one or several 207's through 203 or at any 202's 103. FIG. 3 Page 5 of 10

310—E-Gift Certificate Recipient—is a 108 that receives an email advising him that an E-Gift Certificate is ready for redemption at 202's 103. FIG. 3 Page 6 of 10

311—Purchase Special Offers—is the action of 108 buying one or several 210 at 202's shopping cart if 202's 210 is illuminated, indicating that they have Special Offers active on their 103. FIG. 3 Page 6 of 10

312—Purchase Pre-Fixe™ Menus—is 108 buying one or several 209's at 202's shopping cart given that the 209 button is illuminated, indicating that they have Pre-Fixe™ Menus active on their 103. FIG. 3 Page 7 of 10

313—Purchase Event & Group Dining—is 108 organizing an event for a group at 202's shopping cart given that the 208 button is illuminated, indicating that their Event & Group Dining area is active. FIG. 3 Page 7 of 10

314—Create Event Menu—is where an event organizer selects the menu, the menu items and customizes the menu for their guests and so that the Restaurant can get it ready to print. FIG. 3 Page 8 of 10

315—Event Guest—is a 108 that has been invited to attend an event, needs to confirm attendance, or make payments at a specific 202. FIG. 3 Page 8 of 10

316—Add to Cart—is 108 placing selected items for purchase on 103. FIG. 3 Page 9 of 10

317—Log In—is 108 entering their username and password in order to make purchases, redeem an E-Gift Certificate, confirm attendance and/or pay for an event at 100. FIG. 3 Page 9 of 10

318—Continue Shopping—is an option that 108 has after 315 to browse and or shop for other items at the same or several 202's. FIG. 3 Page 10 of 10

319—Check Out—is an option that 108 has after 315 to proceed directly to 109. FIG. 3 Page 10 of 10

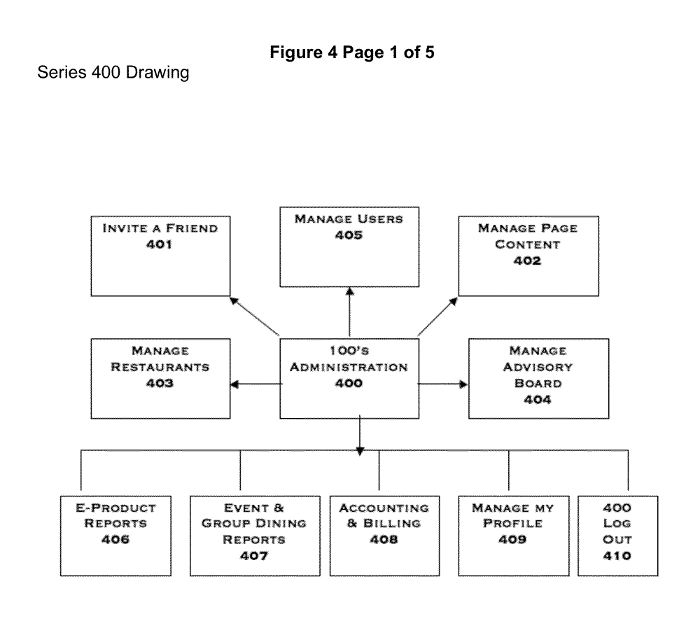

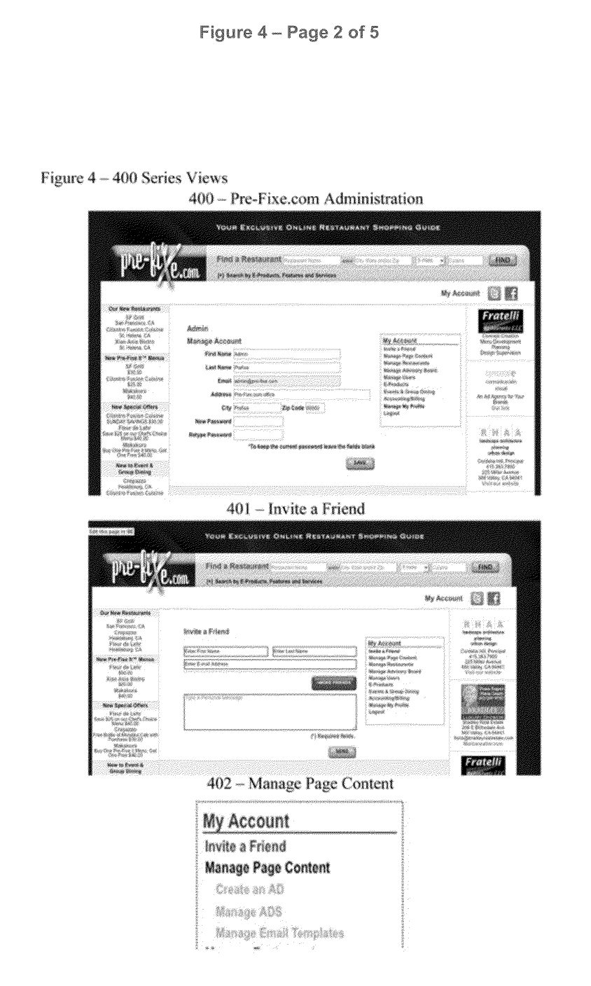

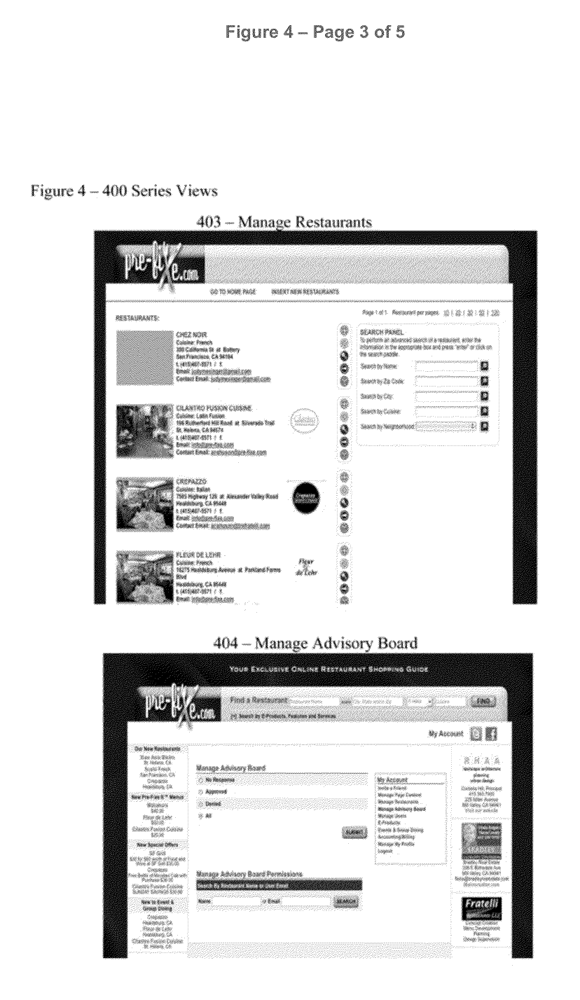

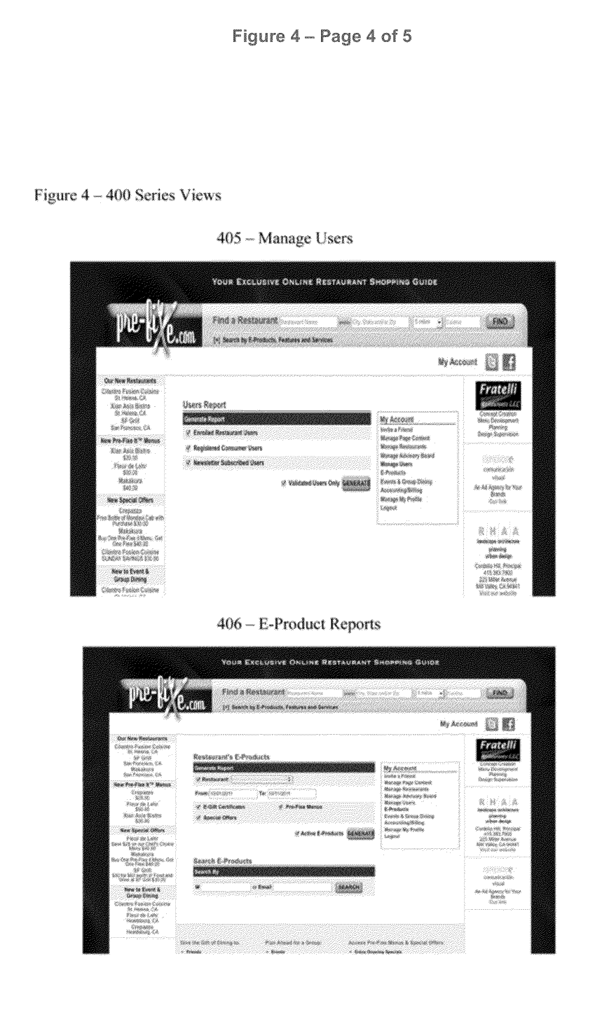

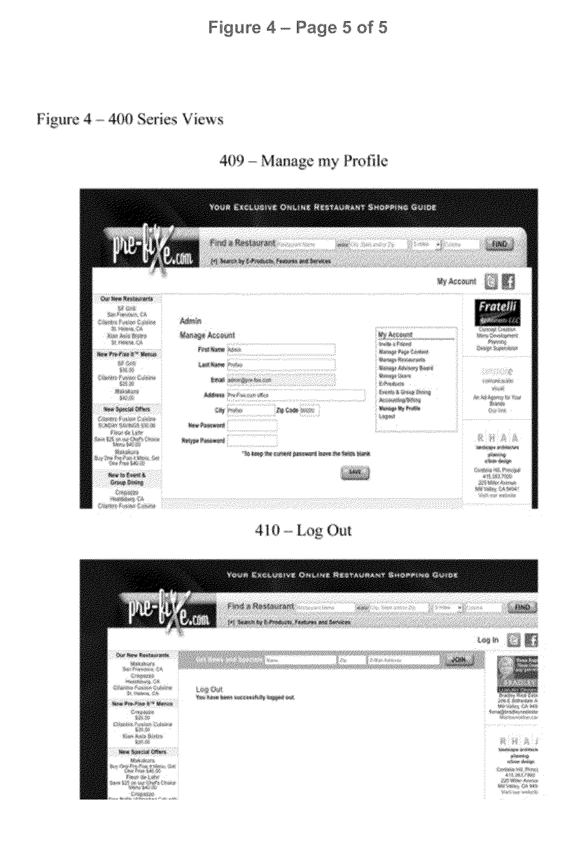

400 Series—Pre-Fixe Administration My Account Area FIG. 4 Page 1 of 115

400—100's Administration—is composed of Pre-Fixe LLC™ principals, employees and/or independent contractors who manage 100's activities listed throughout the series 100, 200 and 300 and as described below within the 100's area of “My Account”. FIG. 4—Page 2 of 5

401—Invite a Friend—is a link within the “My Account” area accessible to anyone who has a username and password with 100 to an email form that allows invitations to friends to join 100. FIG. 4—Page 2 of 5

402—Manage Page Content—is a link within the “My Account” area that allows 400 to enter into the following administration areas of 100: FIG. 4—Page 2 of 5
1. Create an Ad, an area where 400 can create banner ads an advertiser as described in 114.
Manage Ads, an area where 400 can preview, edit and/or delete an existing banner ad.
2. Manage Email Templates, an area that stores several automated email responses to a variety of actions and can be customized by 400. Email Templates are divided into four categories:
   a. Restaurant Enrollment Actions, include the following Email Templates:
      i. Advisory Board Invitation Template invites selected merchants to experience 100 and post their testimonials, a photograph and their biography.
      i. Enrollment Solicitation Template sends an email acknowledging a Restaurant Enrollment application received by 100.
      ii. Enrollment Solicitation Response-Denial Template is the email that is sent to 212's currently nor accepted to participate in 100.
      iii. Restaurant Invitation Template is the email sent to 101's chosen by 400, or to 212's approved by 400.
      iv. Webmaster Email Template is the email form that contains the code that enables 202's to create 204.
   b. Account Management consists of email templates for the following actions:
      i. Email Verification for New Account Template is the email sent to verify a 108 that has performed 308 and is now a registered user.
      ii. Email Verification for Restaurant Template is the email sent to verify 101's that have opened a 201 and are now a 202.
      i. Password Recovery Template is the email sent to verify that 100 is allowing a registered user to create a new password by recognizing the user's email address.
      ii. Register User E-Gift Certificate Template is the email sent to a 310 prompting to 315 in order to redeem and view their 207.
   c. User & E-Product Notifications consists of email templates for the following actions:
      i. E-Gift Certificate Template is the email sent to 310's. This template prompts the recipient to 308 allowing them to redeem their 207.
      ii. E-Products Payment Template is the email sent by the System Method to thank and confirm the purchase by 108.
      iii. Event Invitation Notification Template is the email sent by the System Method when an organizer sends an invitation to 314 notifying them of the event details including a link to confirm attendance and/or pay as required.
      iv. Invite a Friend Template allows 400 to edit the message and fields that appears in 401.
      v. Special Offer Template is the email sent by 100 to confirm the purchase of a Special Offer along with its terms and conditions.
   d. Other Functions is an area designated for additional Email Templates including the following:
      i. Affiliate Inquiry Template is the email received by 100 upon anyone filling out the Affiliate Enrollment form located at the 111 link that appears on the home page and the main pages of this website.

403—Manage Restaurants—is a link within the “My Account” area that allows 400 to manage 101's and 202's and perform the following actions: 1. Insert New Restaurants either by entering one at a time or by exporting multiple Restaurants from a CSV file, 2. Search for specific Restaurants by name, zip code, city, cuisine or neighborhood; 3. Invite 101's to join 100's Advisory Board, or invite 101's to become 202's, 4. Manage, write, edit and upload 103 and 106 content, 5. Deactivate a 202 at 400's sole discretion and 6. Delete a 202 at 400's sole discretion. FIG. 4—Page 3 of 5

404—Manage Advisory Board—is a link within the “My Account” that allows two actions: 1. Manage Testimonials area that allows 400 to view 101's that have been invited to join the Advisory Board including views by the following action categories: a. No Testimonial are views of 101's who have not yet responded to an Advisory Board Invitation, but have agreed to our Advisory Board Merchant License Agreement, b. Testimonial Approved by Admin are those who have agreed to become 202's and are invited to comment and post testimonials, c. Denied are Advisory Board Members whose testimonial is not agreeable to 400 and does not get posted. d. View All allows 400 to view all testimonials. 2. Manage Members: a. No Response area allows 400 to view those who have not responded, b. Accepted Membership allows 400 to view the list of Advisory Board Members, c. Declined Membership allows 400 to view the list of those who have declined the invitation. FIG. 4—Page 3 of 5

405—Manage Users—is the “My Account” area that allows 400 to view and manage all types of users.

406—E-Product Reports—allows 400 to view data by 202 by date ranges, by 104. In addition this area allows 400 to search by E-Product purchase order number, or by the email attached to such E-Product purchase.

407—Events & Group Dining Reports—allows 400 to view data by 202, date ranges, active and inactive events. In addition, this area allows 400 to search by event name or by email.

408—Accounting/Billing—allows 400 to view data and generate 113 by 202, date ranges, 104. In addition, this area allows 400 to search by purchase order or by email. FIG. 4—Page 5 of 5

409—Manage My Profile—allows 400 to edit management's name and last name, address, city state and re-set the password. This area also allows 400 to issue limited permissions to other 400 employees and independent contractors to have limited views of areas under their management and not to the entire system. FIG. 4—Page 5 of 5

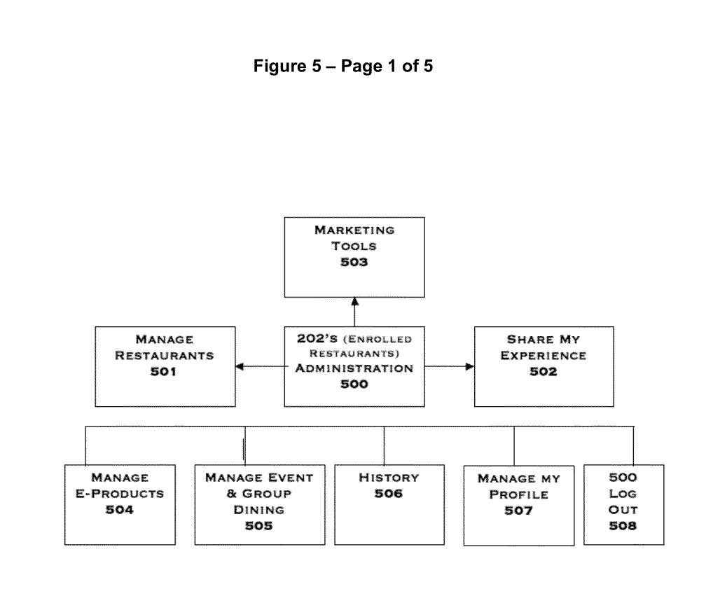

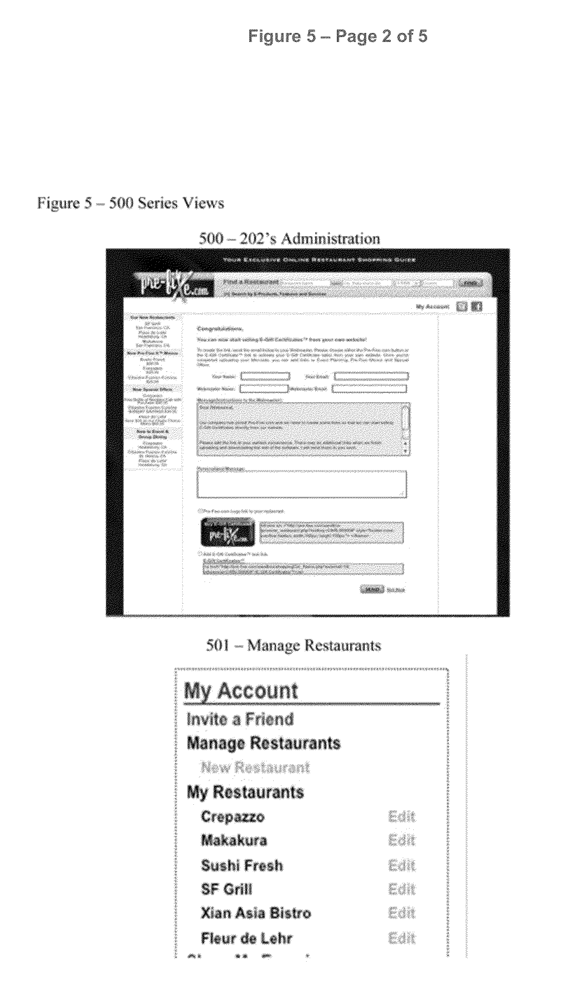

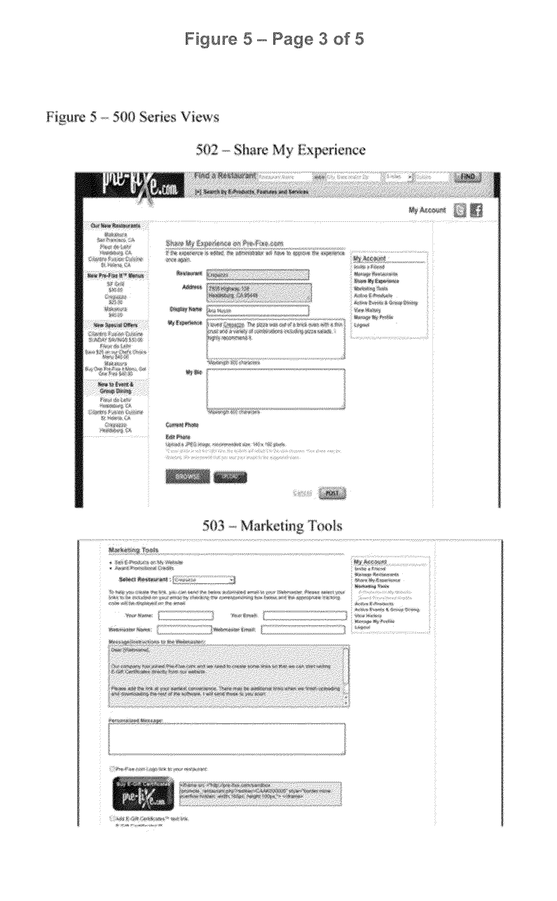

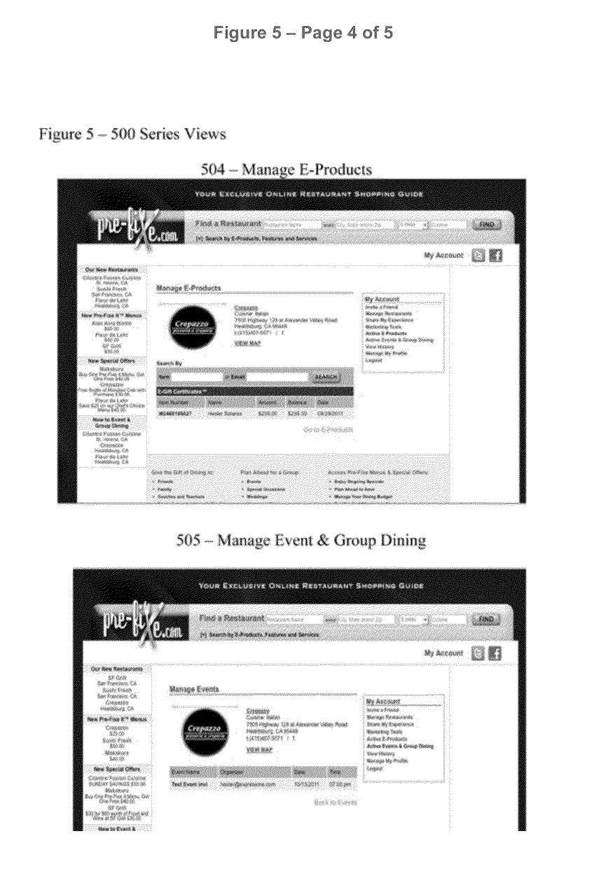

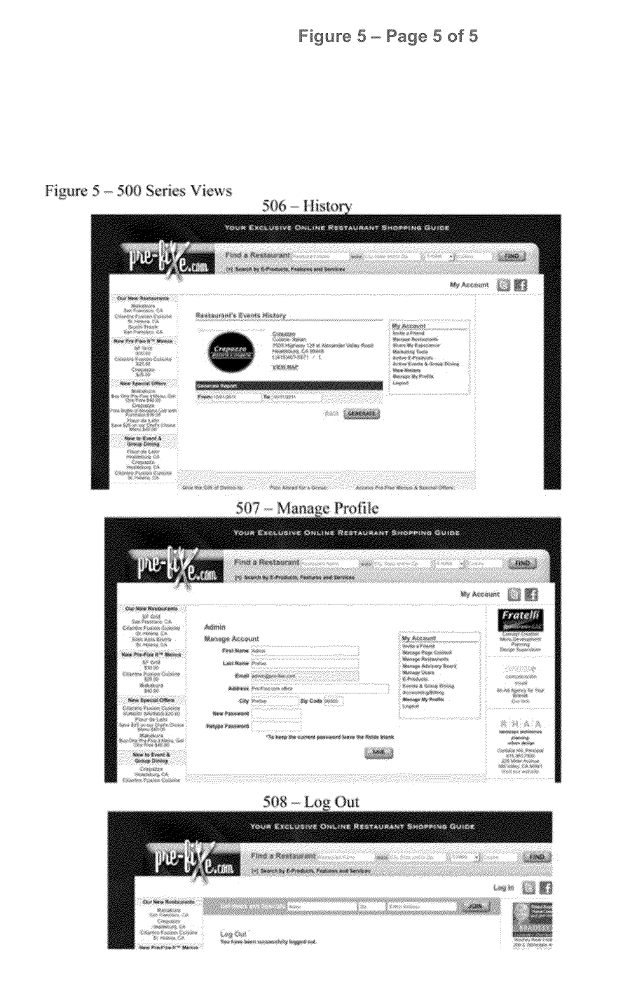

500 Series—My Account Area FIG. 5—Page 1 of 5

500—202's Administration—is composed of 202's principals, employees and/or independent contractors who manage activities listed throughout the series 100, 200 and 300 and as described below within the “My Account” area of 202. FIG. 5—Page 2 of 5

501—Manage Restaurants—allows 500's to perform the following tasks: 1) New Restaurant, a link to “Enroll a Restaurant” area requesting 400 to send a 200, 2) Edit, add or continue to upload information onto 103 and 106. FIG. 5—Page 2 of 5

502—Share My Experience—allows 500's who are part of 100's Advisory Board to write a testimonial that describes their experience at 100. The System Method sends an email to 400 for review and/or approval. If approved, it is posted through the “Testimonials” link that appears in the home page and all of the main pages of 100. They can also add their biography, add a photograph and edit existing information. In the event of a change, the System Method sends an email to 400 for further approval. FIG. 5—Page 3 of 5

503—Marketing Tools—allows 500 to perform two actions: 1) Send the Webmaster an email with the code to create a link for each featured 104 E-Product(s) or one link to the Pre-Fixe.com logo. These links take 108 directly on to 202's 103, 2) Award Promotional Credits, an action that allows 202's to reward loyalty through either a discount code or credits that are dollar for dollar credits valid towards goods and services at 202. FIG. 5—Page 3 of 5

504—Manage E-Products—allows 500 to deduct used credits and issue any refunds and search by item number, or by email to view 108's active E-Products. If 500 is also a 108, they can also view their active E-Products. FIG. 5—Page 4 of 5

505—Manage Event & Group Dining—view of 208 activity by 202's, date ranges, active events and search to view events by name or email. FIG. 5—Page 4 of 5

506—View History—allows 500 to view all activity and generate 113 reports by 202, date ranges, E-Products and search by item number or email. FIG. 5—Page 5 of 5

507—Manage My Profile—allows 500 to edit management's name, address, city, state and re-set the password. FIG. 5—Page 5 of 5

508—Logout—allows 500 to sign off. FIG. 5—Page 5 of 5

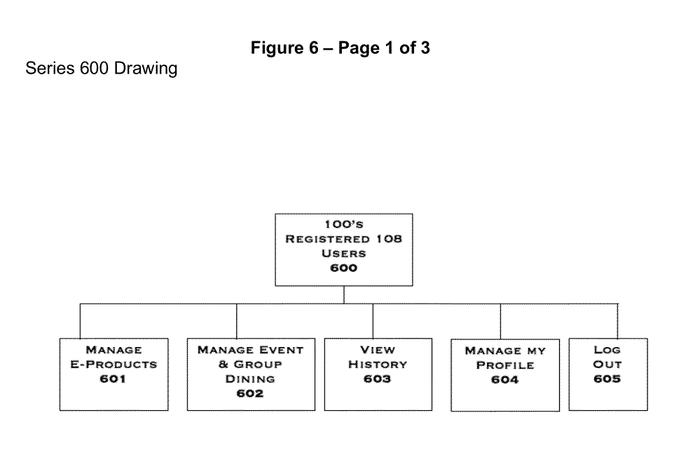

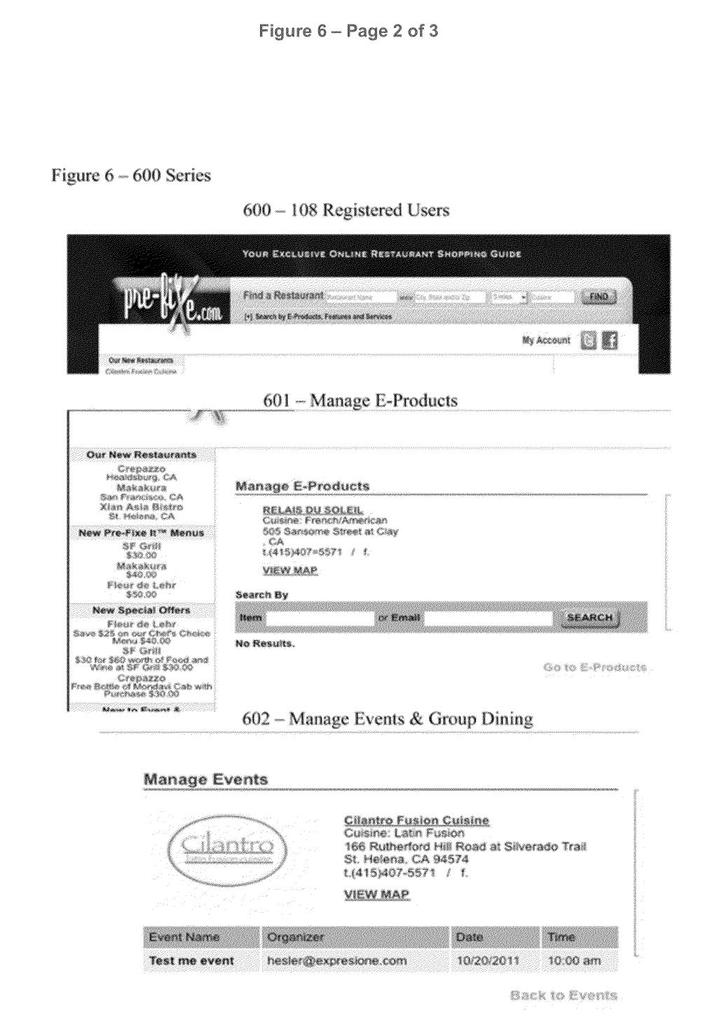

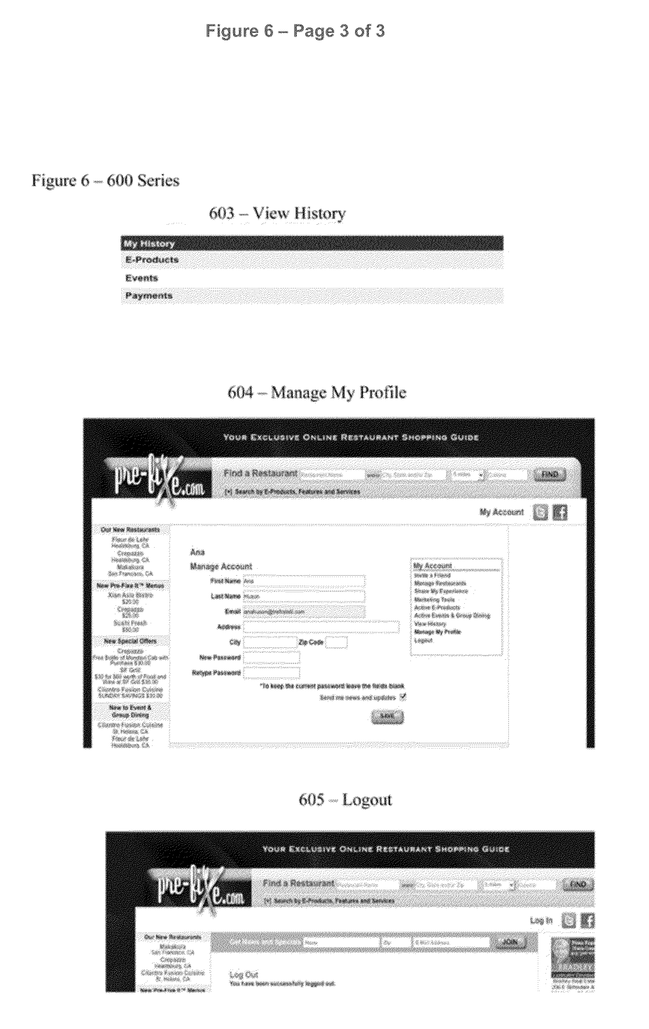

600 Series—100's Registered 108 Account Area FIG. 6—Page 1 of 3

600—Registered 108's manage their account by entering username and password. FIG. 6—Page 2 of 3

601—Manage E-Products—allows 600 to review active E-Products. In this area, 600 can consolidate unused credit balances and create new E-Gift Certificate or to re-gift. Consolidation and re-gifting is only allowed within one Restaurant. FIG. 6—Page 2 of 3

602—Manage Events & Group Dining—allows 600 to view any active events that need an RSVP, payment or have outstanding credits. Once an event has passed, these credits will also appear in 601 in the form of an E-Gift Certificate so that 600 can consolidate and/or re-gift within a particular Restaurant. FIG. 6—Page 2 of 3

603—View History—allows 600 to view and generate 113 reports by 202's, date ranges, E-Product purchases or E-Gift Certificates sent and/or received, and by item number. FIG. 6—Page 3 of 3

604—Manage My Profile—allows 600 to edit name, address, city, state and re-set the password. FIG. 6—Page 3 of 3

605—Logout—allows 600 to sign off. FIG. 6—Page 3 of 3

What is claimed is:

1. A System Method and Internet portal called Pre-Fixe.com™ accessible through http://www.pre-fixe.com designed to offer an environment-friendly ongoing solution that enables merchants within specific industries, not currently taking full advantage of E-commerce, to sell their goods and services online with no printing required with each purchase assigned a uniquely identifiable transaction number. Through this invention, multiple merchants are invited to create their own automated Microsites and shopping carts to sell a uniquely designed Suite of E-Products (Independent claim 2 see below) from a single portal powered by our new software, The System Method follows the steps below:
a. Generates an email invitation to merchants inviting them to join Pre-Fixe.com™.
b. Provides a link to the Merchant License Agreement that must be signed.
c. Asks merchant to create a username and password.
d. Guides the merchant to activate their online store at Pre-Fixe.com.
e. Generates an automated code for the merchant's webmaster to create a link to their Microsite. The merchant can decide to send the email to the Webmaster immediately, or at a later time.
f. Allows anyone to request to enroll a Restaurant through the “Enroll a Restaurant” link. When the Pre-Fixe.com administration receives such a request, they will determine whether or not to send an invitation. If the restaurant qualifies, the invitation is sent. Otherwise, a regret email is sent and the Restaurant request is placed on a waiting list completely at the discretion of the Pre-Fixe LLC™ management and its guidelines.
g. Allows conventional searches by name, city, state or zip code, mile radius and cuisine.

2. The Pre-Fixe.com™ System Method includes proprietary software created to enable merchants within one industry to sell their goods and services online through the Pre-Fixe.com Suite of E-Products and empower them to sell E-Gift Certificates, Event & Group Dining, Pre-Fixe Menus and Special Offers as described below:
a. Quick Buy: a mini-store that appears directly on the search results page featuring a drop down menu of fixed dollar amounts, a field to enter any denomination and information on the average price per person at that Restaurant.
b. E-Gift Certificates™ button: a link that illuminates as soon as the merchant accepts the terms and conditions of the Merchant License Agreement. It allows purchases through a drop down menu of fixed dollar amounts, a field to enter any denomination, and a built-in calculator to enter the number of people in a party times the average price per person at that Restaurant.
c. Creates the “All-Inclusive Dining Calculator” where merchants enter information about their average pricing to increase sales and help consumers estimate what the cost of dining at this establishment may be by adding allowances for:
i. Wine bottles based on the average price of a wine bottle entered by the merchant.
ii. Corkage fee times the number of bottles consumer will bring.
iii. A beverage allowance field with information on the average cost of a well and brand name drink.
iv. A field to add a gratuity percentage guided by a merchant suggested percentage or through a field where consumer can add a different percentage gratuity.
v. An allowance for local sales tax based on the city tax entered by merchant. Pre-Fixe.com™ DOES NOT COLLECT SALES TAX. ALL AMOUNTS DISPLAYED BY THE ALL-INCLUSIVE DINING CALCULATOR ARE ESTIMATES ONLY and dollar for dollar credits valid towards any goods and/or services at the merchant's establishment.
d. Prompts merchants to activate the Event & Group Dining area of the Microsite through choosing to upload and/or enter the following information:
i. Group Pre-Fixe™ Menus: Fields to enter price per person, the menu item choices by course and the number of items that are allowed on such menu for each course.
ii. A la Carte Group Menus: Fields to enter each item by course category individually priced.
iii. Chefs Choice Group Menu: A field to enter the price and upload images of pre-existing group price fixed menus.
iv. Activates and illuminates the Event & Group Dining button/link once information is entered by merchant to allow consumer access.
v. Allows consumer to select a menu, a price and upload an image and a title or message if they choose from the Group Pre-Fixe™ Menus or the A la Carte Menu. Chefs Choice Menus are not currently customizable.
vi. Provides a “NEXT” button that takes consumer to the All-Inclusive Dining Calculator.
vii. Displays a Total So Far window for consumer to view the running total of the purchase and the breakdown per guest total.
viii. Provides a “NEXT” button that takes consumer to the Add Guest Details page to send the invitation by email through different options:
ix. Field to enter emails manually separated by commas.
x. Import from public email contact databases such as Gmail, Hotmail and AOL.
xi. Import an email list from an Excel CVS file contact database.
xii. A system generated email to their computer email program that includes a link that prompts guests to register themselves for the event.
xiii. Adds a “Round off to the nearest $10 check box to the Estimated Total So Far calculator window to reach a more rounded FIG. if selected.
xiv. Prompts consumer/organizer to save their work to send invitation now or later. The “send later” button takes consumers to the My Account area where the information entered is saved and where it can be accessed to send later or to add additional guests.
xv. Provides access to the event through the My Account>Active Events & Group Dining area. The Pre-Fixe.com™ Administration, the event organizer and the guest can view and manage their events from this area of the System Method.
xvi. Allows the organizer to pre-pay for the full event in one payment or issue separate checks, which the System Method splits according to the number of people defined by the organizer and prompts guests to pre-pay for their portion of the meal as specified and set by the organizer.
xvii. Saves the Restaurant valuable employee time providing a System Method for consumers to view, plan, create and customize their group menus online.
xviii. Prompts the merchant to continue uploading and activating the other products offered by Pre-Fixe.com™ on their Microsite or they can postpone it for later.
e. Provides the merchant access to upload their Pre-Fixe™ Menus—multi-coursed price fixed menus that may also include beverage or wine options. In this area, the merchant can upload the following types of Pre-Fixe™ Menus:
i. Ongoing Pre-Fixe™ Menus are menus already featured by the Restaurant on a specific merchant determined schedule. Merchant can upload an image of the Ongoing Pre-Fixe™ Menu, enter the price per person and enter the schedule, availability and the terms and conditions they wish to impose for its redemption.
ii. Pre-Fixe™ it Menus are further discounted price fixed menus available only at Pre-Fixe.com™. Pre-Fixe LLC™ requests that these menus are lower in price and feature different menu items by course than the Ongoing Pre-Fixe™ Menus and are designed to increase traffic during off peak hours. The merchant must enter the menu items offered by course, can include specific wine brands per course and add the description, the price and the schedule/availability and the terms and conditions they wish to impose for its redemption.
f. Prompts merchant to finish activating the Store and Shopping Cart area of their Microsite by activating Special Offers. The Special Offers area of the System Method allows merchants to:
i. Create a Special Offer by choosing and customizing from a list of sample Special Offers, or posting their own.
ii. Define the terms and conditions and schedule/availability of the offer by choosing and customizing from a list of sample terms and conditions or posting their own.
iii. Name the Special Offer, specify a schedule of availability, enter the number of offers and allow a count down view.
iv. Create a merchant hosted dated and/or ticketed event through the Event & Group Dining area and proceed to send out invitations either to their own customer base or allow it to be a public event viewed and received by the Pre-Fixe.com™ contact database and email campaigns.
g. Provides merchants with a promotional editorial page where they can upload the following:
i. Images of their logo, their establishment and key personnel,
ii. An editorial write up, and key personnel biographies and,
iii. Create links to reviews and social media pages.
h. Activate the Features & Services search filters by entering the restaurant details in the forms provided by the system within the following categories:
i. Pre-Fixe.com™ Suite of E-Products comprised of the merchant activated E-Gift Certificates™; Event & Group Dining Software; Pre-Fixe™ Menus and Special Offers.
ii. Reservations, Price & Payments to search by credit cards accepted, the average price per person, reservation policies and whether or not they offer online reservations.
iii. Food & Beverage search filters by full bar, bar dining, happy hour or brunch schedule, and gluten free menu items and if it's a family-friendly Restaurant.
iv. Groups & Events search filters for venues for wedding, conferences and private rooms, including room capacity.
v. Ambiance search filters by noise level, views, dress code, fireplace availability, outdoor dining preferences or romantic environment.
vi. Special Services search filters for wireless Internet and wheelchair access.
vii. Parking Services search filters for on-premise parking and/or valet parking.

3. The Pre-Fixe.com™ System Method includes a uniquely comprehensive My Account area programmed for merchants, consumers and the Pre-Fixe.com administration which allows them to manage their account and includes a uniquely designed dual purpose advertising program as follows:
a. My Account Area for the merchant includes:
i. The Primary Contact Information area is where merchant can change the name of the merchant's business, the physical address, the cross street, the neighborhood, this website link, the map link, the public email contact information and the merchant's administrator name and any link for their online reservation program. To change the Administrator email, for security reasons merchant must request such change to the Pre-Fixe.com™ Administration.
ii. The E-Gift Certificate™ area is where merchant can change the information featured in the All-Inclusive Calculator, including the average price per person, the gratuity and sales tax percentages, the corkage fee, the average price of a wine bottle and the average price for well and brand cocktails.
iii. The Event & Group Dining area is where merchants can change the group menu prices, the menu items and their descriptions, and where new menu images can be uploaded.
iv. The Pre-Fixe™ Menu area is where merchants can edit Pre-Fixe Menu prices available for individual purchases, the menu items and their descriptions and upload new menu images.
v. The Special Offers area is where merchants can change, customize, date, add or end their Special Offers and upload images.
vi. The editorial and image area is where merchants can change the editorial write up, the personnel biographies and upload images of their featured personnel and their Restaurant, add and/or delete images of their establishment and their social media links.
vii. The My Account area is where the System Method stores all sales and purchases and generates e-mails advising merchants, consumers and the Pre-Fixe.com™ administration of related activity.
viii. Prompts merchants to manage their account through the My Account area that appears upon a merchant logging into the system by using their username and password. The My Account menu allows merchants to:
a. Invite a Friend through a link where merchants can encourage customers to join Pre-Fixe.com™ through an email and a personalized message. This helps the merchant promote its Microsite by alerting their email contact list of their participation. It also helps populate the site and allows the Pre-Fixe Administration to send email campaigns to those who decide to join.
b. Manage Restaurant Microsite(s) under their administration.
c. Post a testimonial to share their experience, which upon approval by Pre-Fixe LLC™ personnel, gets posted.
d. Access a Marketing Tools link from which they can send emails to the webmaster with the code needed to create links on the merchant website and activate the sales of E-Gift Certificates™, Event & Group Dining, Pre-Fixe™ Menus and Special Offers directly from the merchant Website. From this area, merchants can reward customer loyalty by awarding promotional credits or discount codes to any of the consumers that have made purchases at their Pre-Fixe.com™ Microsite. merchant can choose the people by geographical area and/or by selecting a purchase date range.
e. Access Active E-Products to search for account balances and deduct credit usage from consumer accounts by entering the purchase order number or the consumer's email.
f. Access the Event & Group Dining link to view upcoming event information including payment history, closing date and attendee information by event title and/or date.
g. Access the View History page and view historical sales by date range, by E-Product category and generate a report, which may include viewing all sales to date. This report can be exported through an Export CVS button to ease company sales reporting and accounting.
h. Enter the Manage Profile link to update account information and password through the Manage My Profile link.
i. Log out.
b. The My Account Area allows consumers to:
i. Invite a Friend through a link where consumers can invite their friends to join Pre-Fixe.com™ through an email and a personalized message
ii. Post a testimonial to share their experience, which upon approval by Pre-Fixe LLC™ personnel, gets posted.
iii. Access Active E-Products to perform the following tasks:
a. Search for account balances and credit usage by Restaurant.
b. Consolidate any outstanding credits within a single Restaurant from any of their active E-Product. Once credits have been consolidated, they appear as a new E-Gift Certificate™ on the consumer's account for future usage at merchant's establishment.
c. Buy E-Products with consolidated credits is activated through a Buy Now window. These credits can be applied towards any E-Product purchase for self or to re-gift to others by purchasing an E-Gift Certificate™.
d. Access the Active Event & Group Dining link to view upcoming event information including payment history, closing date and should the consumer be the organizer, view attendee information by event title and/or date.
e. Access the View History page and view historical purchases and receipts of all E-Products by merchant, date and credit balance and usage.
f. Enter the Manage Profile link to update account information and password through the Manage My Profile link.
g. Log out.
c. My Account Area Banner Advertising Program includes the following:
i. Automates a merchant banner style listing located on the left hand side of the home page and other main pages of this website as soon as a Restaurant joins Pre-Fixe.com™. The System Method is programmed to feature up to three Restaurants in each banner. The System Method is programmed to arbitrarily rotate all Restaurants that have activated a particular E-Product during the last 45 days. Each banner is titled with each of the E-Product names as follows:
a. “Our New Restaurants” banner that showcases and promotes merchants that have joined Pre-Fixe.com™ and are now selling E-Gift Certificates™ through the Quick Buy feature and through the illuminated E-Gift Certificate™ button.
b. A “New Pre-Fixe It™ Menus” banner that showcases and promotes new Pre-Fixe.com™ merchants offering further discounted Pre-Fixe It™ Menus for sale at Pre-Fixe.com™.
c. A “New Special Offers” banner that showcases and promotes merchants that have recently posted new Special Offers.
d. A “New to Event & Group Dining” banner that showcases and promotes merchants who have activated the Event & Group Dining area of this website.
ii. Offers a Banner Advertising Program that is unique to the Pre-Fixe.com™ Invention Method during its first year of operations. This program is called “A-Penny-Per-Day-Per-Restaurant Banner Advertising Program” whereby contacted advertisers can upload their banners free of charge. Through a dedicated Advertising Store accessible through a link at Pre-Fixe.com™, the advertiser's credit card on file will charge them a penny per day for every Restaurant that signs on to the Pre-Fixe.com™ portal. In the future, and when Pre-Fixe.com™ has enough statistical data on sales and hits and registered users, conventional banner ad sales will be activated through the traditional advertising online banner programs such as pay-per-click, impressions and pay-per-sale. Four distinctive banner ad kinds will be sold through the Pre-Fixe.com™ unique Advertising Program:
a. Banner Ads directed exclusively to Restaurant merchants. These banner ads are designed for food and beverage industry suppliers, producers, vendors and distributors to post ads that promote the sale of their brands to the merchant and allow them to add their products to their Event & Group Dining Menus, their Pre-Fixe™ Menus and their Special Offers.
b. Banner Ads directed exclusively to Pre-Fixe.com™ registered users. These banner ads can further promote the purchase of the featured product offers and menus, or simply promote their brands amongst the Pre-Fixe.com™ registered consumer database.
c. Banner Ads that are public or anonymous viewed by anyone who is not logged into the Pre-Fixe.com™ website.
d. The Pre-Fixe.com™ Administration can choose to have a Banner Ad viewed by one or all three of the aforementioned profiles.
